(19) United States
(12) Patent Application Publication
(10) Pub. No.: US 2019/0210610 A1
(43) Pub. Date: Jul. 11, 2019

(54) FUEL EFFICIENCY ESTIMATION SYSTEM, FUEL EFFICIENCY ESTIMATION METHOD, AND COMPUTER READABLE MEDIUM

(71) Applicant: MITSUBISHI ELECTRIC CORPORATION, Tokyo (JP)

(72) Inventors: Tomoharu TAKEUCHI, Tokyo (JP); Norimitsu NAGASHIMA, Tokyo (JP); Takeshi TAKEUCHI, Tokyo (JP)

(73) Assignee: MITSUBISHI ELECTRIC CORPORATION, Tokyo (JP)

(21) Appl. No.: 16/324,046

(22) PCT Filed: Sep. 29, 2016
(86) PCT No.: PCT/JP2016/078944

§ 371 Date: Feb. 7, 2019

(51) Int. Cl. B60W 50/00; B60W 40/04; G01C 21/34

(52) U.S. Cl. CPC B60W 50/0097; B60W 40/04; G01C 21/3469; G08G 1/096708; B60W 2050/0077; B60W 2520/10; B60W 2720/10

(57) ABSTRACT

A fuel efficiency estimation system includes a velocity profile generation unit (245) to generate a velocity profile indicating a change in velocity of a motor vehicle traveling a traveling route. Also, the fuel efficiency estimation system includes a stop judgment unit (244) to judge, based on a stop probability (331) at which the motor vehicle stops at an intersection that is present on the traveling route and connection information (321) between a traffic signal installed at the intersection and a traffic signal installed at an intersection adjacent to the intersection, stop/nonstop of the motor vehicle at the intersection. Furthermore, the fuel efficiency estimation system includes a velocity correction unit (246) to correct the velocity profile (441) based on the stop/nonstop and a fuel efficiency calculation unit (247) to calculate fuel efficiency of the motor vehicle traveling the traveling route based on the corrected velocity profile (451).

### TECHNICAL FIELD

The present invention relates to fuel efficiency estimation systems, fuel efficiency estimation methods, and fuel efficiency estimation programs, which estimate traveling fuel efficiency of a motor vehicle. In particular, the present invention relates to technology of estimating traveling fuel efficiency of a motor vehicle with high accuracy by estimating with a high accuracy a velocity profile indicating a change in actual traveling velocity when the motor vehicle travels a specific traveling route.

### BACKGROUND ART

In recent years, EVs (Electric Vehicles), HEVs (Hybrid Electric Vehicles), and PHEVs (plug-in Hybrid Electric Vehicles) have become increasingly widespread. With these becoming widespread, for the purpose of an increase in distance that can be traveled by motor vehicles and an improvement in fuel efficiency, technical developments have been made for optimization of a traveling plan with low fuel efficiency, such as switching between electric driving and gasoline driving.

In making this traveling plan with low fuel efficiency, it is required to estimate motor-vehicle traveling fuel efficiency when traveling a specific traveling route.

As for technology for estimating motor-vehicle traveling fuel efficiency, for example, as in Patent Literature 1, a scheme has been suggested in which a predicted value of the number of stops in accordance with the time zone is found by using an average space between intersections or traffic signals and traveling history to generate a predicted waveform of a traveling pattern, thereby estimating fuel efficiency with high accuracy.

### CITATION LIST

### Patent Literature

Patent Literature 1: JP 2001-183150

### SUMMARY OF INVENTION

### Technical Problem

In the scheme according to Patent Literature 1, by utilizing at least either of road characteristics and statistic information, a judgment is made as to intersection stop when traveling a specific traveling route. In this scheme, however, merely an independent stop prediction for each intersection is made, and connections between traffic signals are not taken into consideration. Therefore, the accuracy of stop prediction is low at the time of, for example, traveling a route with contiguous traffic signals under connection control.

An object of the present invention is to achieve estimation of motor-vehicle traveling fuel efficiency with high accuracy by utilizing stop probabilities at intersections based on traveling history information of a vehicle and connection information of traffic signals acquired from infrastructure information as for estimation of motor-vehicle traveling fuel efficiency to make a judgment as to intersection stop also including connection control of the traffic signal, thereby improving accuracy of intersection stop judgment.

### Solution to Problem

A fuel efficiency estimation system according to the present invention includes:

a velocity profile generation unit to generate a velocity profile indicating a change in velocity of a motor vehicle traveling a traveling route;

a stop judgment unit to judge, based on a stop probability at which the motor vehicle stops at an intersection that is present on the traveling route and connected/disconnected operation between a traffic signal installed at the intersection and a traffic signal installed at an intersection adjacent to the intersection, stop/nonstop of the motor vehicle at the intersection;

a velocity correction unit to correct the velocity profile based on the stop/nonstop; and

a fuel efficiency calculation unit to calculate fuel efficiency of the motor vehicle traveling the traveling route based on the velocity profile corrected by the velocity correction unit.

### Advantageous Effects of Invention

According to the fuel efficiency estimation system of the present invention, the velocity profile generation unit generates a velocity profile indicating a change in velocity of a motor vehicle traveling a traveling route. Also, the stop judgment unit judges, based on a stop probability at which the motor vehicle stops at an intersection that is present on the traveling route and connected/disconnected operation between a traffic signal installed at the intersection and a traffic signal installed at an intersection adjacent to the intersection, stop/nonstop of the motor vehicle at the intersection. Furthermore, the velocity correction unit corrects the velocity profile based on the stop/nonstop. Still further, the fuel efficiency calculation unit calculates fuel efficiency of the motor vehicle traveling the traveling route based on the corrected velocity profile. Thus, intersection stop judgment can be made in consideration of connected/disconnected operation with adjacent traffic signals. This can improve accuracy of the velocity profile and can insure estimation accuracy of traveling fuel efficiency.

### BRIEF DESCRIPTION OF DRAWINGS

FIG. 1 illustrates an entire structure of a fuel efficiency estimation system 500 according to Embodiment 1.

FIG. 2 illustrates a structure of a motor vehicle device 100 mounted on a motor vehicle 1 according to Embodiment 1.

FIG. 3 illustrates a structure of a fuel efficiency estimation device 200 according to Embodiment 1.

FIG. 4 is a flowchart of a stop judgment generation process S110 by a stop judgment generation unit 23 of the fuel efficiency estimation device 200 according to Embodiment 1.

FIG. 5 is a flowchart of operation of a traveling history accumulation unit 231 according to Embodiment 1.

FIG. 6 is a flowchart of operation of a connection calculation unit 232 according to Embodiment 1.

FIG. 7 illustrates an image of intersections in a signal traffic connection calculation process for an intersection i according to Embodiment 1.

FIG. 8 is a flowchart of operation of a stop probability calculation unit 233 according to Embodiment 1.

FIG. 9 is a flowchart of a traveling fuel efficiency estimation process S120 by a traveling fuel efficiency estimation unit 24 of the fuel efficiency estimation device 200 according to Embodiment 1.

FIG. 10 is a flowchart of operation of a traveling velocity extraction unit 242 according to Embodiment 1.

FIG. 11 is a flowchart of operation of a stop judgment unit 244 according to Embodiment 1.

FIG. 12 is a flowchart of operation of a velocity profile generation unit 245 according to Embodiment 1.

FIG. 13 is a flowchart of operation of a velocity correction unit 246 according to Embodiment 1.

FIG. 14 illustrates a structure of the motor vehicle device 100 according to a modification example of Embodiment 1.

FIG. 15 illustrates a structure of the fuel efficiency estimation device 200 according to a modification example of Embodiment 1.

FIG. 16 illustrates a functional structure of a fuel efficiency estimation system 500a according to Embodiment 2.

FIG. 17 illustrates a hardware structure of the fuel efficiency estimation system 500a according to Embodiment 2.

FIG. 18 illustrates a system structure of a fuel efficiency estimation system 500b according to Embodiment 3.

FIG. 19 illustrates a functional structure of a motor vehicle device 100b according to Embodiment 3.

FIG. 20 illustrates a functional structure of a traveling history accumulation server 210 according to Embodiment 3.

FIG. 21 illustrates a functional structure of a stop probability calculation server 220 according to Embodiment 3.

FIG. 22 illustrates a functional structure of a connection calculation server 230 according to Embodiment 3.

FIG. 23 illustrates a functional structure of a fuel efficiency calculation server 240 according to Embodiment 3.

FIG. 24 is a flowchart of operation of the traveling history accumulation server 210 according to Embodiment 3.

FIG. 25 is a flowchart of a stop probability calculation process of the stop probability calculation server 220 according to Embodiment 3.

FIG. 26 is a flowchart of a stop probability extraction process of the stop probability calculation server 220 according to Embodiment 3.

FIG. 27 is a flowchart of a connection calculation process of the connection calculation server 230 according to Embodiment 3.

FIG. 28 is a flowchart of a connection extraction process of the connection calculation server 230 according to Embodiment 3.

FIG. 29 is a flowchart of operation of the fuel efficiency calculation server 240 according to Embodiment 3.

FIG. 30 illustrates a system structure of a fuel efficiency estimation system 500c according to Embodiment 4.

FIG. 31 illustrates a functional structure of a motor vehicle device 100c according to Embodiment 4.

FIG. 32 illustrates a functional structure of an information generation calculator 250 according to Embodiment 4.

FIG. 33 illustrates a functional structure of an information accumulation server 260 according to Embodiment 4.

FIG. 34 is a flowchart of an individual connection calculation process of the information generation calculator 250 according to Embodiment 4.

FIG. 35 is a flowchart of an individual stop probability calculation process of the information generation calculator 250 according to Embodiment 4.

FIG. 36 is a flowchart of a connection accumulation process of the information accumulation server 260 according to Embodiment 4.

FIG. 37 is a flowchart of a stop probability accumulation process of the information accumulation server 260 according to Embodiment 4.

FIG. 38 is a flowchart of an intersection information extraction process of the information accumulation server 260 according to Embodiment 4.

### DESCRIPTION OF EMBODIMENTS

In the following, embodiments of the present invention are described by using the drawings. In each drawing, identical or equivalent portions are provided with a same reference character. In the description of the embodiments, description of identical or equivalent portions is omitted or simplified as appropriate.

### Embodiment 1

***Description of Structure***

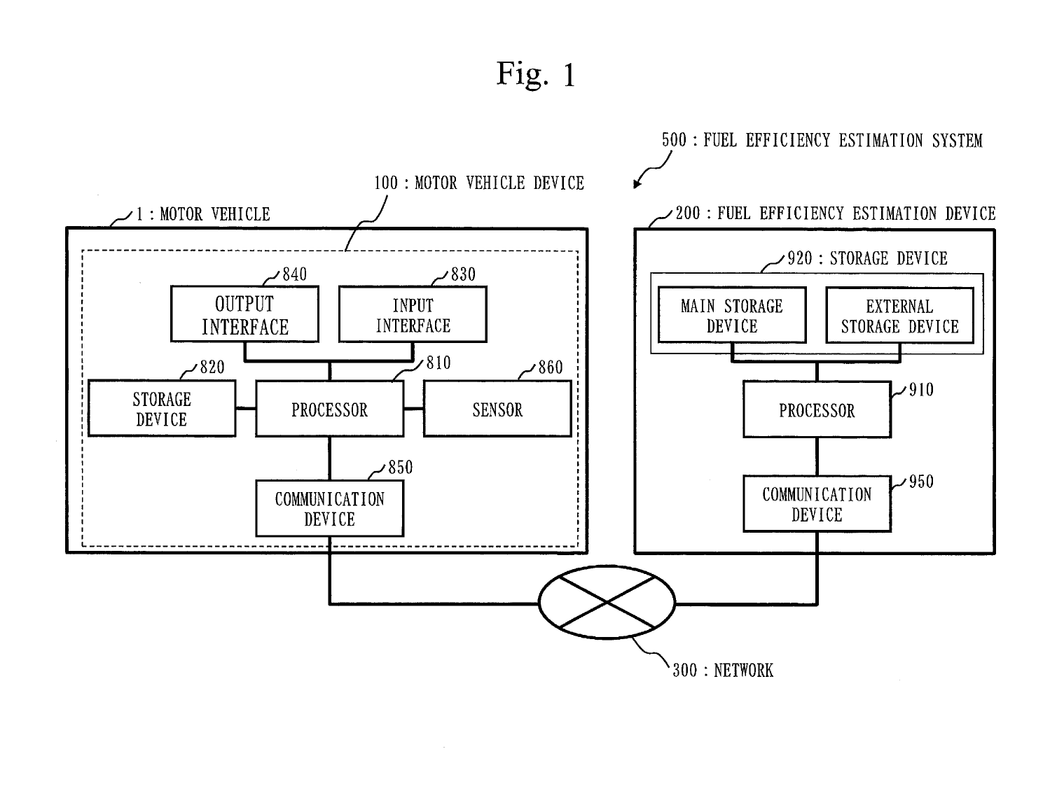

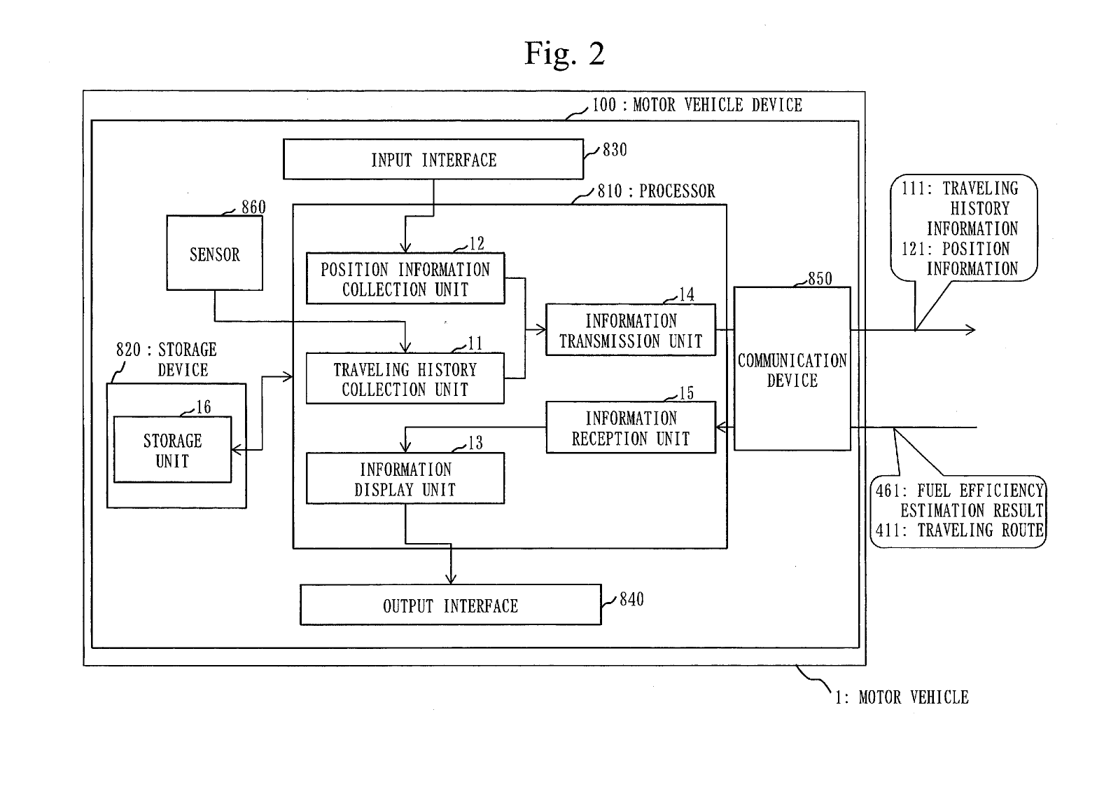

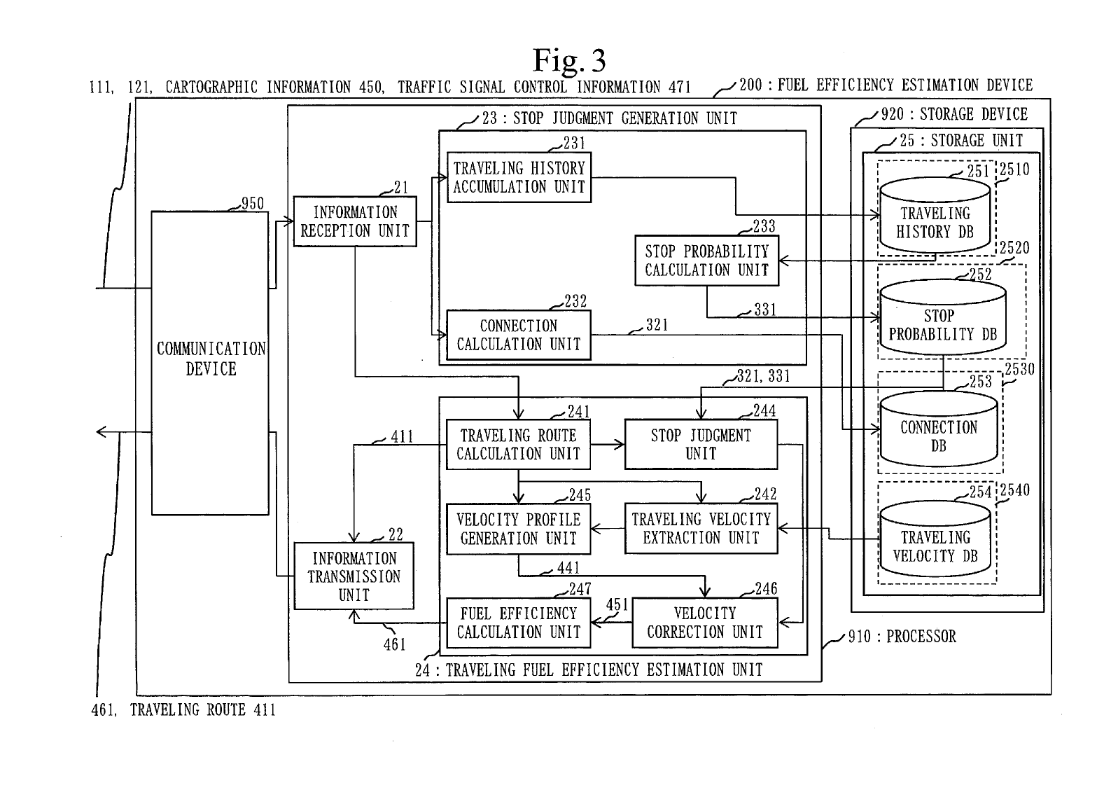

FIG. 1 illustrates an entire structure of a fuel efficiency estimation system 500 according to the present embodiment. FIG. 2 illustrates a structure of a motor vehicle device 100 mounted on a motor vehicle 1 according to the present embodiment. FIG. 3 illustrates a structure of a fuel efficiency estimation device 200 according to the present embodiment. FIG. 1 also illustrates a hardware structure of each device configuring the fuel efficiency estimation system 500.

As illustrated in FIG. 1, the fuel efficiency estimation system 500 includes the motor vehicle device 100 mounted on the motor vehicle 1 as a fuel efficiency estimation target and the fuel efficiency estimation device 200 which communicates with the motor vehicle device 100 via a network 300.

The motor vehicle device 100 is a computer mounted on the motor vehicle 1. The motor vehicle 1 is a vehicle traveling a traveling route 411 by using fuel.

The fuel efficiency estimation device 200 is a computer. The fuel efficiency estimation device 200 estimates motor-vehicle traveling fuel efficiency of the motor vehicle 1 on a specific traveling route. In the following, the motor-vehicle traveling fuel efficiency is also referred to as traveling fuel efficiency or fuel efficiency. The fuel efficiency estimation device 200 is also referred to as a central server. The fuel efficiency estimation device 200 may be a substantial data server or may be configured in the cloud.

As illustrated in FIG. 2, the motor vehicle device 100 includes a processor 810 and other hardware such as a storage device 820, an input interface 830, an output interface 840, a communication device 850, and a sensor 860. The storage device 820 has a memory and an auxiliary storage device.

As illustrated in FIG. 2, the motor vehicle device 100 includes, as functional structures, a traveling history collection unit 11, a position information collection unit 12, an information display unit 13, an information transmission unit 14, an information reception unit 15, and a storage unit 16.

In the following description, the functions of the traveling history collection unit 11, the position information collection unit 12, the information display unit 13, the information transmission unit 14, and the information reception unit 15 of the motor vehicle device 100 are referred to as functions of “units” of the motor vehicle device 100.

The functions of the “units” of the motor vehicle device 100 are implemented by software.

The storage unit 16 is implemented by the storage device 820. Various types of information to be displayed via the output interface 840 on a display, position information 121 received from the input device via the input interface 830, the process results by the processor 810, and so forth are stored in the storage unit 16.

The sensor 860 collects traveling history information 111 such as a traveling position, traveling velocity, and traveling direction of the motor vehicle 1.

Also as illustrated in FIG. 3, the fuel efficiency estimation device 200 includes a processor 910 and other hardware such as a storage device 920 and a communication device 950. Note that the fuel efficiency estimation device 200 may include hardware such as an input interface or an output interface.

As illustrated in FIG. 3, the fuel efficiency estimation device 200 includes, as functional structures, an information reception unit 21, an information transmission unit 22, a stop judgment generation unit 23, a traveling fuel efficiency estimation unit 24, and a storage unit 25. The stop judgment generation unit 23 includes a traveling history accumulation unit 231, a connection calculation unit 232, and a stop probability calculation unit 233. Also, the traveling fuel efficiency estimation unit 24 includes a traveling route calculation unit 241, a traveling velocity extraction unit 242, a stop judgment unit 244, a velocity profile generation unit 245, a velocity correction unit 246, and a fuel efficiency calculation unit 247. Furthermore, a traveling history DB (database) 251, a stop probability DB 252, a connection DB 253, and a traveling velocity DB 254 are stored in the storage unit 25. Still further, values and results of respective arithmetic operation processes regarding fuel efficiency estimation are stored in the storage unit 25. The traveling history DB 251 is an example of a traveling history storage unit 2510. The stop probability DB 252 is an example of a stop probability storage unit 2520. The connection DB 253 is an example of a connection storage unit 2530. The traveling velocity DB 254 is an example of a traveling velocity storage unit 2540.

The functions of the “units” of the fuel efficiency estimation device 200 are implemented by software.

The storage unit 25 is implemented by the storage device 920.

In the following, a specific example of hardware of each of the motor vehicle device 100 and the fuel efficiency estimation device 200 is described.

The processor 810, 910 is connected to other hardware via a signal line to control the other hardware.

The processor 810, 910 is an IC (Integrated Circuit) for processing. The processor 810, 910 is specifically a CPU (Central Processing Unit) or the like.

The input interface 830 is a port connected to an input device such as a mouse, keyboard, or touch panel. The input interface 830 is specifically a USB (Universal Serial Bus) terminal. Note that the input interface 830 may be a port connected to a LAN (Local Area Network).

The output interface 840 is a port to which a cable of a display device such as a display is connected. The output interface 840 is, for example, a USB terminal or HDMI (registered trademark) (High Definition Multimedia Interface) terminal. The display is specifically an LCD (Liquid Crystal Display). In the motor vehicle device 100, the information display unit 13 causes information to be displayed on the display device such as a display of the motor vehicle 1 via the output interface 840. The information display unit 13 causes various types of information such as the traveling route 411 and a fuel efficiency estimation result 461 to be displayed on the display device via the output interface 840 for display and transmission to a driver.

The communication device 850, 950 includes a receiver and a transmitter. Specifically, the communication device 850, 950 is a communication chip or NIC (Network Interface Card). The communication device 850, 950 functions as a communication unit which communicates data. The receiver functions as a reception unit which receives data, and the transmitter functions as a transmission unit which transmits data. The communication device 850, 950 transmits and receives various types of information such as the traveling history information 111, the position information 121, cartographic information 450, traffic signal control information 471, the traveling route 411, and the fuel efficiency estimation result 461.

The storage devices 820 and 920 each have a main storage device and an external storage device.

The external storage device is specifically a ROM (Read Only Memory), flash memory, or HDD (Hard Disk Drive). The main storage device is specifically a RAM (Random Access Memory). The storage unit 16, 25 may be implemented by the external storage device, may be implemented by the main storage device, or may be implemented by both of the main storage device and the external storage device. Any method of implementing the storage unit 16, 25 can be taken.

In the external storage device, a program for achieving the functions of the “units” of each device is stored. This program is loaded onto the main storage device, is read to the processor 810, 910, and is executed by the processor 810, 910. In the external storage device, an OS (Operating System) is also stored. At least part of the OS is loaded onto the main storage device, and the processor 910, 810 executes the program for achieving the functions of the “units” of each device while executing the OS.

Each device may include a plurality of processors replacing the processor 810, 910. The plurality of these processors share execution of the program for achieving the functions of the “units”. Each of these processors is an IC for processing, like the processor 810, 910.

Information, data, a signal value, and a variable value indicating the result of the process by the functions of the “units” of each device is stored in the main storage device, the external storage device, or a register or cache memory of the processor 810, 910. In each of FIG. 2 and FIG. 3, arrows connecting each unit and the respective storage units represent that each unit stores the process result in the storage unit or each unit reads information from the storage unit. Also, arrows connecting the respective units represent flows of control.

The program for achieving the functions of the “units” of each device may be stored in a portable recording medium such as a magnetic disc, flexible disc, optical disc, compact disc, Blu-ray (registered trademark) disc, or DVD (Digital Versatile Disc).

Note that a program for achieving the functions of the “units” of the fuel efficiency estimation system 500 is also referred to as a fuel efficiency estimation program 520. Also, a thing called a fuel efficiency estimation program product is a storage medium and storage device having the fuel efficiency estimation program 520 recorded thereon, and has loaded thereon a computer-readable program, irrespective of what visual format it takes.

***Description of Functional Structures***

First, the functional structure of the motor vehicle device 100 is described.

The traveling history collection unit 11 collects the traveling history information 111 indicating traveling history of the motor vehicle 1 by using the sensor 860.

The position information collection unit 12 receives, from the driver, information about an origin and a destination in the traveling of the motor vehicle 1 as the position information 121. The position information collection unit 12 accepts the position information 121 from the driver via the input interface 830.

The information display unit 13 causes the traveling route 411 calculated by the fuel efficiency estimation device 200 from the position information 121 and the fuel efficiency estimation result 461 of the motor vehicle 1 on the traveling route 411 to be displayed on the display device via the output interface 840.

The information transmission unit 14 transmits the position information 121 including the origin and the destination and the traveling history information 111 indicating the traveling history of the motor vehicle 1 via the communication device 850 to the fuel efficiency estimation device 200.

The information reception unit 15 receives the traveling route 411 and the fuel efficiency estimation result 461 via the communication device 850.

Next, the functional structure of the fuel efficiency estimation device 200 is described.

The information reception unit 21 receives the traveling history information 111 and the position information 121 transmitted from the motor vehicle device 100 and the cartographic information 450 and the traffic signal control information 471, which are infrastructure information, via the communication device 950. The cartographic information 450 is specifically a digital road map.

The information transmission unit 22 transmits the traveling route 411 and the fuel efficiency estimation result 461 in the traveling route 411 via the communication device 950 to the motor vehicle device 100.

The stop judgment generation unit 23 calculates a stop probability 331 and connection information 321 at each intersection nationwide based on the traveling history information 111, the cartographic information 450, and the traffic signal control information 471, which are received by the information reception unit 21, and stores them in the storage unit 25.

The traveling fuel efficiency estimation unit 24 calculates the traveling route 411 based on the position information 121 and the cartographic information 450 received by the information reception unit 21. Also, the traveling fuel efficiency estimation unit 24 calculates traveling fuel efficiency of the motor vehicle on the traveling route 411 as the fuel efficiency estimation result 461.

Each functional structure of the stop judgment generation unit 23 is described.

The traveling history accumulation unit 231 accumulates the traveling history information 111 in the traveling history DB 251 of the storage unit 25.

The connection calculation unit 232 calculates, as the connection information 321, connected/disconnected operation between a traffic signal installed at an intersection that is present on the traveling route 411 and a traffic signal installed at an intersection adjacent to that intersection. The connection calculation unit 232 calculates the connection information 321 based on the cartographic information 450 and the traffic signal control information 471 as infrastructure information. The connection calculation unit 232 calculates the connection information 321 for each of date and time attributes as attributes of date and time, and stores it in the connection DB 253 of the storage unit 25. The connection information 321 is information indicating connected/disconnected operation between traffic signals.

The stop probability calculation unit 233 calculates the stop probability 331 at which the motor vehicle 1 stops at an intersection that is present on the traveling route 411, based on the traveling history information 111 accumulated in the traveling history DB 251. That is, the stop probability calculation unit 233 calculates the stop probability 331 based on the traveling history information 111 collected from the motor vehicle previously traveling the traveling route 411. The stop probability calculation unit 233 calculates the stop probability 331 for each of the date and time attributes as attributes of date and time, and stores it in the stop probability DB 252. The stop probability 331 is also referred to as an intersection stop probability.

Each functional structure of the traveling fuel efficiency estimation unit 24 is described.

The traveling route calculation unit 241 acquires the position information 121 received by the information reception unit 21. The position information 121 includes the origin and the destination. The position information 121 and the cartographic information 450 are examples of traveling route information indicating a traveling route. Also, the information reception unit 21 is an example of an acquisition unit which acquires the position information 121 as traveling route information. The traveling route calculation unit 241 calculates the traveling route 411 in movement from the origin to the destination based on the position information 121 and the cartographic information 450. The traveling route calculation unit 241 outputs the traveling route 411 to the traveling velocity extraction unit 242.

The traveling velocity extraction unit 242 extracts, from the traveling velocity DB 252, a link traveling velocity indicating a traveling velocity at normal time for a link on the digital road map. Here, a link indicates a road section between nodes on the digital road map. Also, a node on the digital road map indicates an intersection, another node in road network representation, or the like. The link is one example of each of a plurality of road sections configuring a road. In the traveling velocity DB 254, link traveling velocities calculated in advance are stored.

Based on the stop probability 331 at which the motor vehicle stops at an intersection that is present on the traveling route 411 and connected/disconnected operation between a traffic signal installed at the intersection and a traffic signal installed at an intersection adjacent to that intersection, the stop judgment unit 244 judges stop/nonstop of the motor vehicle at that intersection. The stop judgment unit 244 corrects the stop probability 331 by using the connection information 321 indicating connected/disconnected operation between traffic signals, and determines stop/nonstop at that intersection based on the corrected stop probability. The stop judgment unit 244 judges intersection stop/nonstop for all intersections on the traveling route 411 calculated by the traveling route calculation unit 241. The stop judgment unit 244 is also referred to as an intersection stop judgment unit. The stop judgment unit 244 judges intersection stop/nonstop for all intersections on the traveling route 411 based on the connection information 321 stored in the connection DB 253 and the stop probability 331 stored in the stop probability DB 252.

The velocity profile generation unit 245 generates a velocity profile 441 indicating a change in velocity of the motor vehicle traveling the traveling route 411. Based on an acquisition date and time when the information reception unit 21 as the acquisition unit acquires the position information 121 and the traveling velocity for each of road sections (links) configuring the traveling route 411, the velocity profile generation unit 245 generates the velocity profile 441 when the traveling route 411 is traveled with date and time attributes of the acquisition date and time. The velocity profile generation unit 245 couples all link traveling velocities on the traveling route 411 together in the order of passing by traveling, thereby generating the velocity profile 441 with intersection nonstop.

The velocity correction unit 246 corrects the velocity profile 441 based on stop/nonstop at the intersection that is present on the traveling route 411. The velocity correction unit 246 corrects the velocity profile 441 with intersection nonstop calculated by the velocity profile generation unit 245 to generate a velocity profile 451 in consideration of intersection stop. The velocity correction unit 246 adds an acceleration/deceleration change due to intersection stop based on the stop judgment result at all intersections on the traveling route 411 calculated by the stop judgment unit 244 to generate the velocity profile 451 in consideration of intersection stop. The velocity correction unit 246 is also referred to as an intersection velocity correction unit.

The fuel efficiency calculation unit 247 calculates fuel efficiency of the motor vehicle traveling the traveling route 411 based on the velocity profile 451 in consideration of intersection stop corrected by the velocity correction unit. The fuel efficiency calculation unit 247 is also referred to as an estimation fuel efficiency calculation unit. Based on the velocity profile 451 in consideration of intersection stop calculated at the velocity correction unit 246, the fuel efficiency calculation unit 247 estimates fuel efficiency in route traveling on the traveling route 411, and outputs it as the fuel efficiency estimation result 461 to the information transmission unit 22.

***Description of Operation***

Next, operations of a fuel efficiency estimation method 510 and the fuel efficiency estimation program 520 of the fuel efficiency estimation system 500 according to the present embodiment are described.

<Stop Judgment Generation Process S110 by Fuel Efficiency Estimation Device 200>

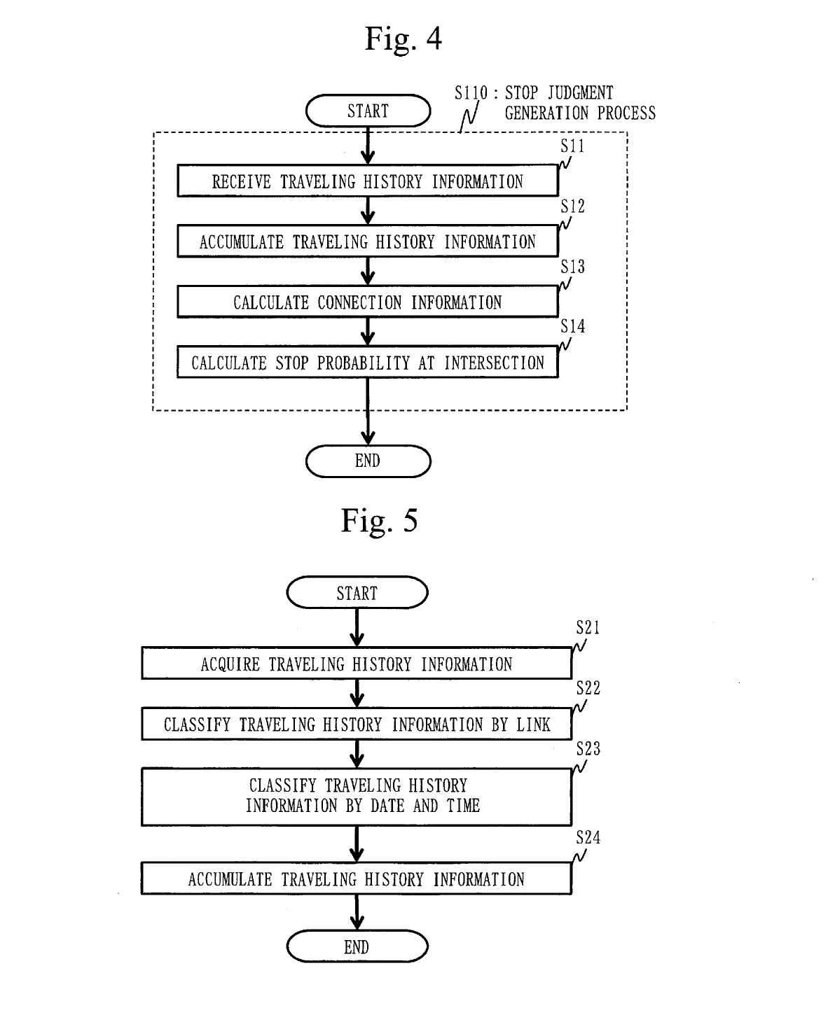

FIG. 4 is a flowchart of a stop judgment generation process S110 by the stop judgment generation unit 23 of the fuel efficiency estimation device 200 according to the present embodiment. The stop judgment generation process S110 is performed entirely at the fuel efficiency estimation device 200 as a central server. The stop judgment generation process S110 is sequentially performed when the information reception unit 21 receives the traveling history information 111 from the motor vehicle device 100 at step S11.

At step S11, the information reception unit 21 receives the traveling history information 111 from the motor vehicle device 100 mounted on the motor vehicle 1.

At step S12, the traveling history accumulation unit 231 accumulates the traveling history information 111 received from the motor vehicle device 100 in the traveling history DB 251 by date and time.

At step S13, the connection calculation unit 232 calculates, by date and time, connected/disconnected operation between traffic signals at each intersection with respect to an adjacent intersection based on the cartographic information 450 and the traffic signal control information 471 as infrastructure information, and accumulates it as the connection information 321 in the connection DB 253.

At step S14, the stop probability calculation unit 233 calculates, by date and time, the stop probability at each intersection based on the traveling history information 111 accumulated in the storage unit 25, and accumulates it as the stop probability 331 in the stop probability DB 252.

Here, “by date and time” specifically refers to classification by date and time attribute such as time, day of the week, or season. Classification by time specifically refers to classification at thirty-minute intervals, one-hour intervals, or the like. Classification by season specifically refers to “by month”. A division interval of time and season can improve estimation accuracy of traveling fuel efficiency of the motor vehicle as fragmentation proceeds. On the other hand, the division interval of date and time may be increased in accordance with the process load on the fuel efficiency estimation device 200 and the number of motor vehicles capable of transmitting the traveling history information 111.

Also, in the stop judgment generation process S110, each of the processes at step S12, step S13, and step S14 may be in a mode of being each processed independently. Here, the process at step S14 is assumed to be performed after at least the process at step S12 is performed once or more. On the other hand, the processes at step S12 and step S13 are assumed to be able to be performed even if other processes are not performed once.

Also, when the respective processes in the stop judgment generation process S110 are performed independently, the respective processes at step S12, step S13, and step S14 may be offline processes. In the offline processes, for example, the process at step S12 is performed once a day, the process at step S13 is performed once a month, and the process at step S14 is performed once a month. In this manner, a process execution interval is required to be appropriately set in consideration of the process load to be applied to the fuel efficiency estimation device 200.

FIG. 5 is a flowchart of operation of the traveling history accumulation unit 231 according to the present embodiment. FIG. 5 illustrates details of the process at step S12 of FIG. 4.

At step S21, the traveling history accumulation unit 231 acquires the traveling history information 111 from the information reception unit 21. Here, the traveling history information 111 includes at least a traveling position, traveling velocity, traveling direction, and traveling date and time information. Also, the traveling history information 111 can be information-divided by link and by date and time. Also, the traveling history information 111 may have a traveling link, acceleration, gradient, weather at the time of traveling, road congestion situation at the time of traveling, and so forth.

At step S22, the traveling history accumulation unit 231 classifies the traveling history information 111 by link. Here, the traveling history accumulation unit 231 extracts position information for each link from the cartographic information 450, matches the extracted information with the traveling position in the traveling history information 111, and judges a link which the motor vehicle 1 having the motor vehicle device 100 that has transmitted the traveling history information 111 mounted thereon has traveled. Note that if the traveling history information 111 includes traveling link information as information about a link traveled, this traveling link information may be extracted to judge a link. Also, the traveling history accumulation unit 231 may acquire the cartographic information 450 and configuration information about links on the roads nationwide by utilizing digital cartographic information and link information being used in, for example, VICS (registered trademark) (Vehicle Information and Communication System: road traffic information communication system) or the like.

At step S23, the traveling history accumulation unit 231 classifies the link-divided traveling history information 111 by date and time. Here, based on the traveling date and time information included in the traveling history information 111, the information is divided by time (for example, thirty-minute intervals), day of the week, and season (for example, by month) as a division unit.

At step S24, the traveling history accumulation unit 231 accumulates the traveling history information 111 classified by link and by date and time in the traveling history DB 251. Here, statistical information such as an average traveling velocity and the number of pieces of accumulated data of the traveling history information 111 by link and by date and time may be simultaneously accumulated.

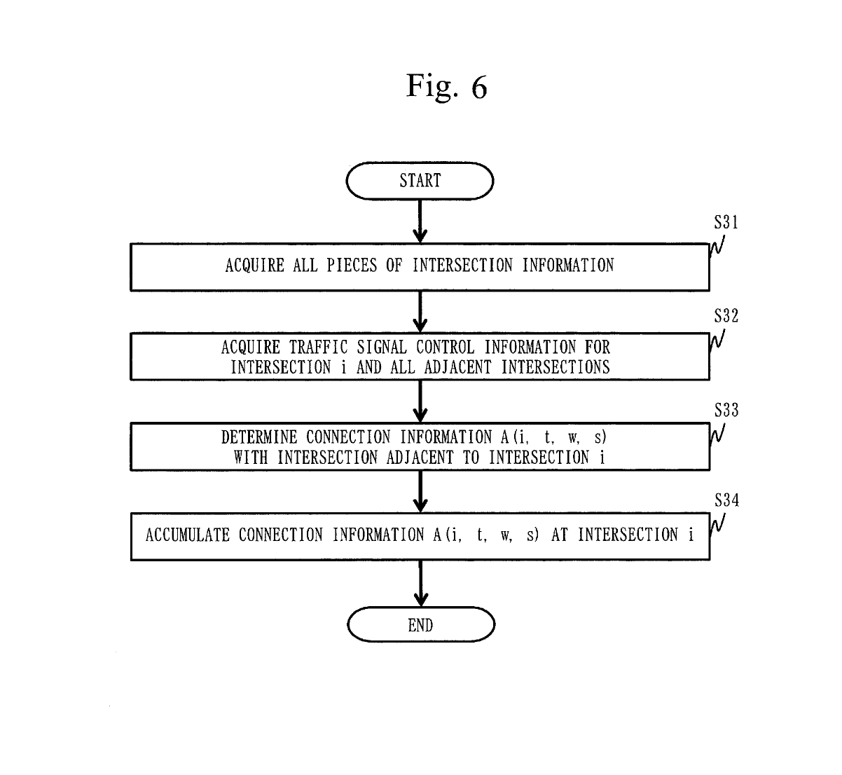

FIG. 6 is a flowchart of operation of a connection calculation unit 232 according to the present embodiment. FIG. 6 illustrates details of the process of step S13 of FIG. 4.

At step S31, the connection calculation unit 232 acquires, from the cartographic information 450, all pieces of intersection information required for calculation of the connection information 321. Here, the information to be acquired is information regarding as to whether a traffic signal has been installed and traffic signal connection information for each intersection. Intersections whose information is to be acquired are the intersection i as a target for calculation of the connection information 321 and all adjacent intersections that can flow into this intersection i. As the cartographic information 450, digital cartographic information being used by a car navigation system or the like for map display and route calculation may be used.

At step S32, the connection calculation unit 232 acquires traffic signal control information for the intersection i and the all adjacent intersections. Here, the traffic signal control information to be acquired is control information for all traffic signals on roads managed by the National Police Agency or a traffic control system, and includes information about traffic progressive control and area traffic control over traffic signals.

At step S33, based on the received traffic signal control information, the connection calculation unit 232 calculates the connection information 321 of the intersection i and all adjacent intersections and takes it as connection information A(i, t, w, s) by date and time. Here, as for each date and time, the connection information A(i, t, w, s) is calculated by the time t (for example, thirty-minute interval), by the day of the week w, and by the season s (for example, by month).

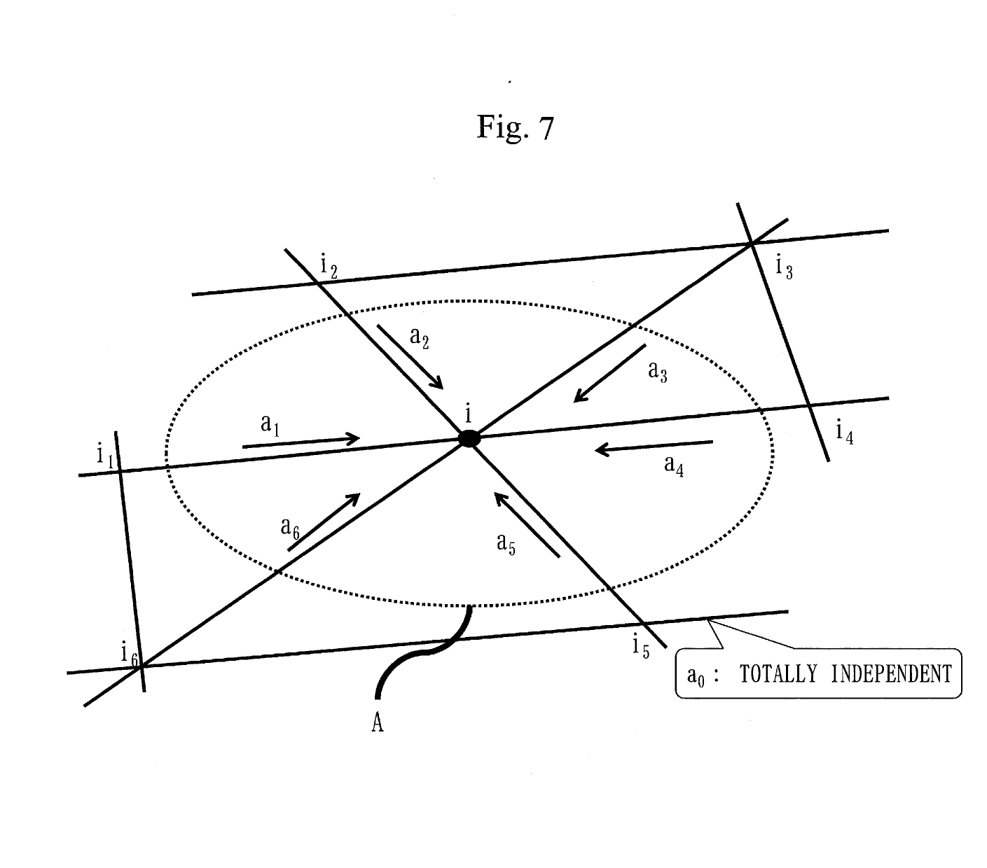

FIG. 7 illustrates an image of intersections in a signal traffic connection calculation process for the intersection i according to the present embodiment. In FIG. 7, each solid line indicates a road, and a location where lines cross is an intersection. In FIG. 7, description is made to the case in which the connection information 321 is calculated for the intersection i.

When all adjacent intersections that can flow into the intersection i are iₖ (1≤k≤6) and connection information with the intersection iₖ is aₖ (1≤l≤6, 0≤aₖ≤1 (connected operation: aₖ=1, disconnected operation: aₖ=0)), the connection information A(i, t, w, s) at the time t (for example, thirty-minute interval), the day of the week w, and the season s (for example, by month) can be represented by a vector as in an expression (1). Here, a₀ is information as to whether the intersection i is independent from all adjacent intersections (independent: 1, connected operation: 0).

FORMULA 1

A(i,t,w,s)=(a₀,a₁, . . . ,aⱼ) (1)

At step S34, the connection calculation unit 232 accumulates the connection information A(i, t, w, s) at the intersection i in the connection DB 253.

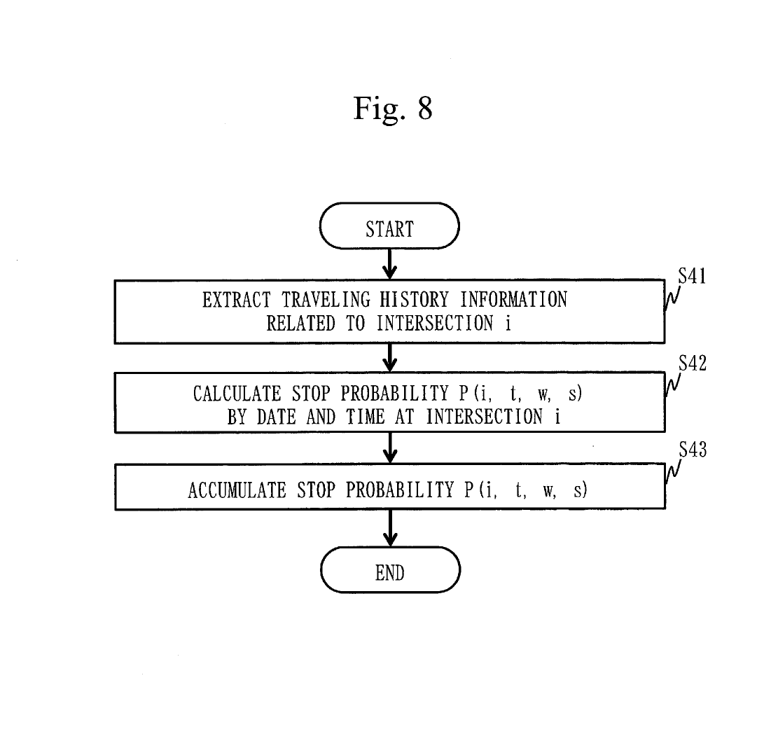

FIG. 8 is a flowchart of operation of a stop probability calculation unit 233 according to the present embodiment. The present process illustrates details of the process at step S14 of FIG. 4.

At step S41, the stop probability calculation unit 233 extracts the traveling history information 111 related to the intersection i from the traveling history DB 251. Here, in particular, it is only required to extract the traveling history information regarding stop/nonstop at the intersection i from the traveling history DB 251, and information about an adjacent intersection that can flow into the intersection i is not required.

At step S42, the stop probability calculation unit 233 calculates the stop probability 331 by date and time at the intersection i. Here, when stop/nonstop information at the intersection i at a time t (for example, a thirty-minute interval), a day of the week w, and a season s (for example, by month) related to the intersection i and extracted from the traveling history information 111 is I(i, t, w, s, n) (1≤n≤Nᵢ), the stop probability P(i, t, w, s) at the intersection i is as in an expression (2). Here, n indicates the number of pieces of stop/nonstop information at the intersection i.

$$\begin{matrix}FORMULA 2 & \\ P ( i , t , w , s ) = \frac{1}{{N}_{i}} {{\sum }_{n}}^{{N}_{i}} I ( i , t , w , s , n ) & ( 2 )\end{matrix}$$

At step S43, the stop probability calculation unit 233 accumulates the calculated stop probability P(i, t, w, s) in the stop probability DB 252. Here, when accumulation in the traveling history DB 251 is small and the accuracy of statistical information is considered as poor, any stop probability at the intersection set in advance may be stored.

<Traveling Fuel Efficiency Estimation Process S120 by Fuel Efficiency Estimation Device 200>

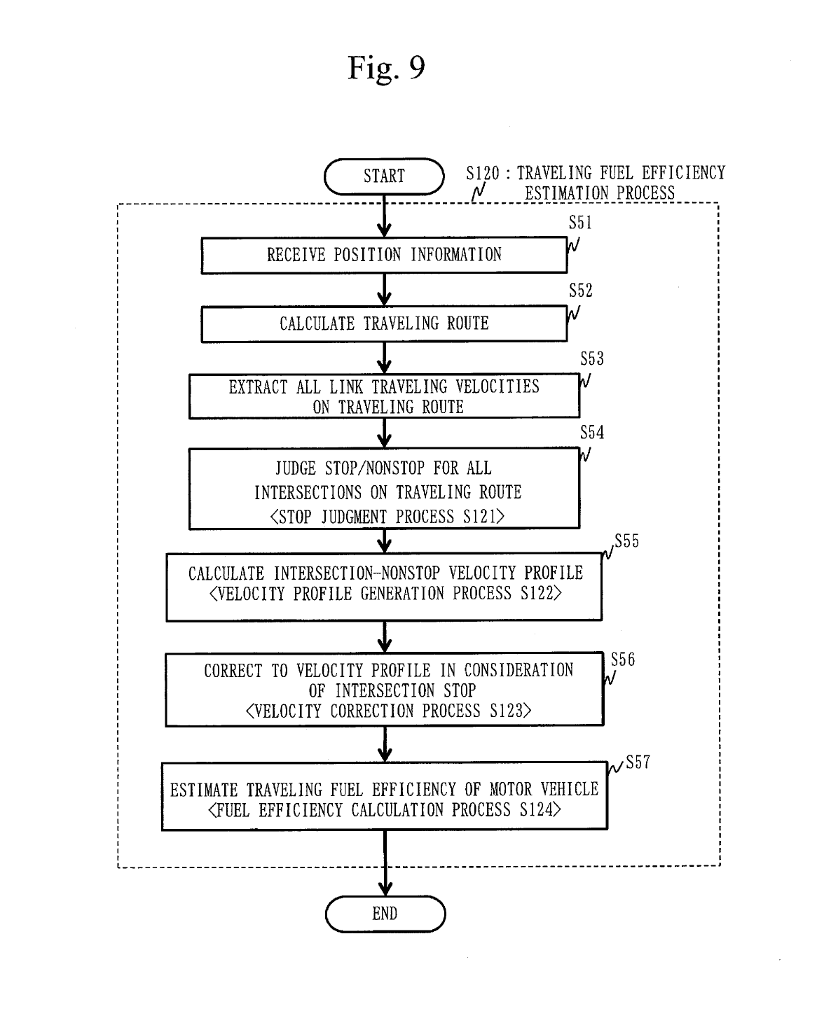

FIG. 9 is a flowchart of a traveling fuel efficiency estimation process S120 by the traveling fuel efficiency estimation unit 24 of the fuel efficiency estimation device 200 according to the present embodiment. The traveling fuel efficiency estimation process S120 is performed at the fuel efficiency estimation device 200 as a central server. The traveling fuel efficiency estimation process S120 is sequentially performed when the information reception unit 21 receives the position information 121 including the origin and the destination from the motor vehicle 1 (step S51). Note that, in the following, description is exemplarily made to the case in which an acquisition date and time (time t₀, day of the week w₀, season s₀) when the information reception unit 21 as the acquisition unit acquires the position information 121 as traveling route information is taken as an estimation date and time for estimation of traveling fuel efficiency of the motor vehicle 1.

At step S52, the traveling route calculation unit 241 calculates a traveling route X of the motor vehicle based on the position information 121 including the origin and the destination received from the motor vehicle 1.

At step S53, the traveling velocity extraction unit 242 extracts, from the traveling velocity DB 254, a link traveling velocity V(Lₖ, tₖ, wₖ, sₖ) (1≤k≤n) for all passage links on the traveling route X.

At step S54, the stop judgment unit 244 judges intersection stop/nonstop S(i₁) to S(iₘ) for all intersections iₜ to iₘ on the traveling route X. The process at step S54 is an example of a stop judgment process S121 in which, based on a stop probability P at an intersection i that is present on the traveling route X where the motor vehicle may stop and connected/disconnected operation between a traffic signal installed at the intersection i and a traffic signal installed at an intersection adjacent to the intersection i, stop/nonstop of the motor vehicle at the intersection i is judged.

At step S55, by using the link traveling velocity V(Lₖ, tₖ, wₖ, sₖ) (1≤k≤n) extracted by the traveling velocity extraction unit 242, the velocity profile generation unit 245 calculates an intersection-nonstop velocity profile V_{profile-nonstop}(X) in traveling the traveling route X. That is, based on the acquisition date and time (time t₀, day of the week w₀, season s₀) and the link traveling velocity V(Lₖ, tₖ, wₖ, sₖ) (1≤k≤n) for all passage links on the traveling route X, the velocity profile generation unit 245 generates a velocity profile when the traveling route X is traveled at the date and time with the same date and time attributes as those of the acquisition date and time. The process at step S55 is an example of a velocity profile generation process S122 of generating the intersection-nonstop velocity profile V_{profile-nonstop}(X) indicating a change in velocity of the motor vehicle traveling on the traveling route X.

At step S56, the velocity correction unit 246 reproduces, on the intersection-nonstop velocity profile V_{profile-nonstop}(X) calculated by the velocity profile generation unit 245, an acceleration/deceleration occurring due to intersection stop by the intersection stop/nonstop S(iᵢ) to S(iₘ) judged at the stop judgment unit 244, and calculates the velocity profile V_{profile}(X) in consideration of intersection stop. The process at step S56 is an example of a velocity correction process S123 of correcting the intersection-nonstop velocity profile V_{profile-nonstop}(X) to velocity profile V_{profile}(X) in consideration of intersection stop based on stop/nonstop at the intersections judged in the stop judgment process S121.

At step S57, for the velocity profile V_{profile}(X) in consideration of intersection stop calculated by the velocity correction unit 246, the fuel efficiency calculation unit 247 estimates traveling fuel efficiency of the motor vehicle in traveling the traveling route X by using a relational expression of fuel efficiency and traveling velocity. The process at step S57 is an example of a fuel efficiency calculation process S124 of calculating fuel efficiency of the motor vehicle traveling the traveling route X based on the velocity profile V_{profile}(X) in consideration of intersection stop corrected by the velocity correction process S123.

Here, as a scheme for use in calculation of the traveling route X in the process at step S52, a scheme such as Dijkstra method for use in current car navigation or the like may be used. Also, when a plurality of traveling routes can be thought from the origin to the destination, the process of FIG. 9 is repeatedly performed as many as the number of traveling routes.

Also, as for the process at step S57, traveling fuel efficiency of the motor vehicle 1 is calculated by using a relational expression of traveling velocity and fuel efficiency. When a relational expression of the traveling velocity V and fuel efficiency is represented as f_{fuel}(V), consumed fuel efficiency F_{fuel} in traveling the traveling route X is as in an expression (3).

FORMULA 3

F_{fuel}=∫_{X}f_{fuel}(V_{profile}(X))dX (3)

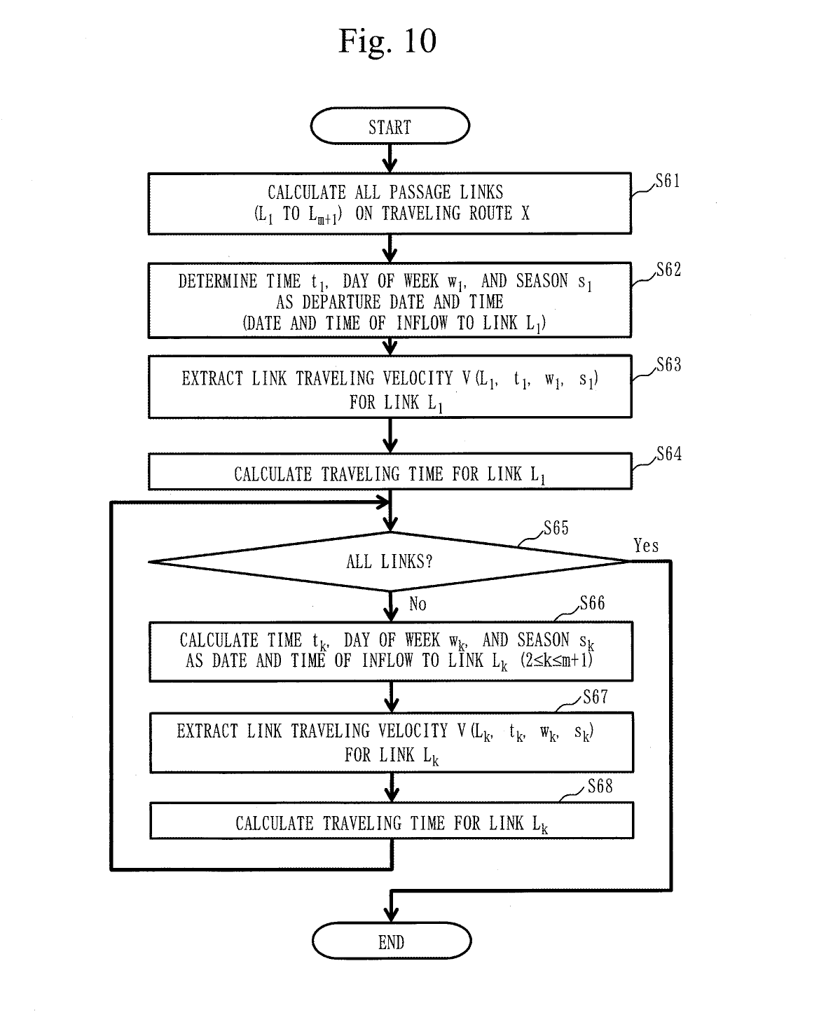

FIG. 10 is a flowchart of operation of the traveling velocity extraction unit 242 according to the present embodiment. FIG. 10 illustrates details of the process at step S53 of FIG. 9.

At step S61, the traveling velocity extraction unit 242 calculates all links (L₁ to Lₘ₊₁) on the traveling route X calculated by the traveling route calculation unit 241. Here, in calculating all links on the traveling route, the traveling velocity extraction unit 242 performs extraction based on the cartographic information 450, and takes the links as L₁, L₂, . . . , Lₘ₊₁ in the order of passing.

At step S62, the traveling velocity extraction unit 242 determines a time t₁, day of the week w₁, and season s₁, as a departure date and time in traveling the traveling route X, that is, a date and time of inflow to the link L₁ to be first traveled on the traveling route X. Here, when a date and time when the position information 121 is received (time t₀, day of the week w₀, season s₀) is taken as a date and time for estimation of traveling fuel efficiency of the motor vehicle, t₁=t₀, w₁=w₀, and s₁=s₀ hold. Also, any time and date (t_{ϕ}, w_{ϕ}, s_{ϕ}) other than the date and time when the position information 121 is received is taken as a date and time for estimation of traveling fuel efficiency of the motor vehicle, t₁=t_{ϕ}, w₁=w_{ϕ}, and s₁=s_{ϕ} hold.

Next at step S63, the traveling velocity extraction unit 242 extracts, from the traveling velocity DB 254, a link traveling velocity V(L₁, t₁, w₁, s₁) for the link L₁ at the time t₁, the day of the week w₁, and the season s₁.

At step S64, the traveling velocity extraction unit 242 calculates a traveling time T₁ in traveling on the link L₁. Here, when the link length of the link L₁ is taken as X₁, the traveling time T₁ for the link L₁ is calculated from the product of the link traveling velocity V(L₁, t₁, w₁, s₁) and the link length X₁.

At step S65, the traveling velocity extraction unit 242 judges whether extraction of the link traveling velocity has been completed for all links. If extraction of the link traveling velocity has been completed for all links, the process ends. If there is a link for which extraction of the link traveling velocity has not been completed, the process proceeds to step S66.

At step S66, for a link Lₖ (2≤k≤m+1) for which extraction of the link traveling velocity has not been completed, the traveling velocity extraction unit 242 determines a time tₖ, day of the week wₖ, and season sₖ as a date and time of inflow to the link Lₖ. Here, calculation is performed based on the traveling time Tₖ₋₁ for the link Lₖ₋₁ calculated in the process at step S64 or step S68. The time tₖ, the day of the week wₖ, and the season sₖ are determined by taking a date and time passing from a time tₖ₋₁, day of the week wₖ₋₁, and season sₖ₋₁, which are a date and time of inflow to the link Lₖ₋₁, by Tₖ₋₁ as a date and time of inflow to the link Lₖ.

Next at step S67, the traveling velocity extraction unit 242 extracts the link traveling velocity V(Lₖ, tₖ, wₖ, sₖ) for the link Lₖ at the time tₖ, the day of the week wₖ, and the season sₖ from the traveling velocity DB 252.

At step S68, the traveling velocity extraction unit 242 calculates a traveling velocity Tₖ in traveling on the link Lₖ. Here, when the link length of the link Lₖ is Xₖ, the traveling time Tₖ for the link Lₖ is calculated from the product of the link traveling velocity V(Lₖ, tₖ, wₖ, sₖ) and the link length Xₖ. After the process at step S68 ends, the process returns to the process at step S65.

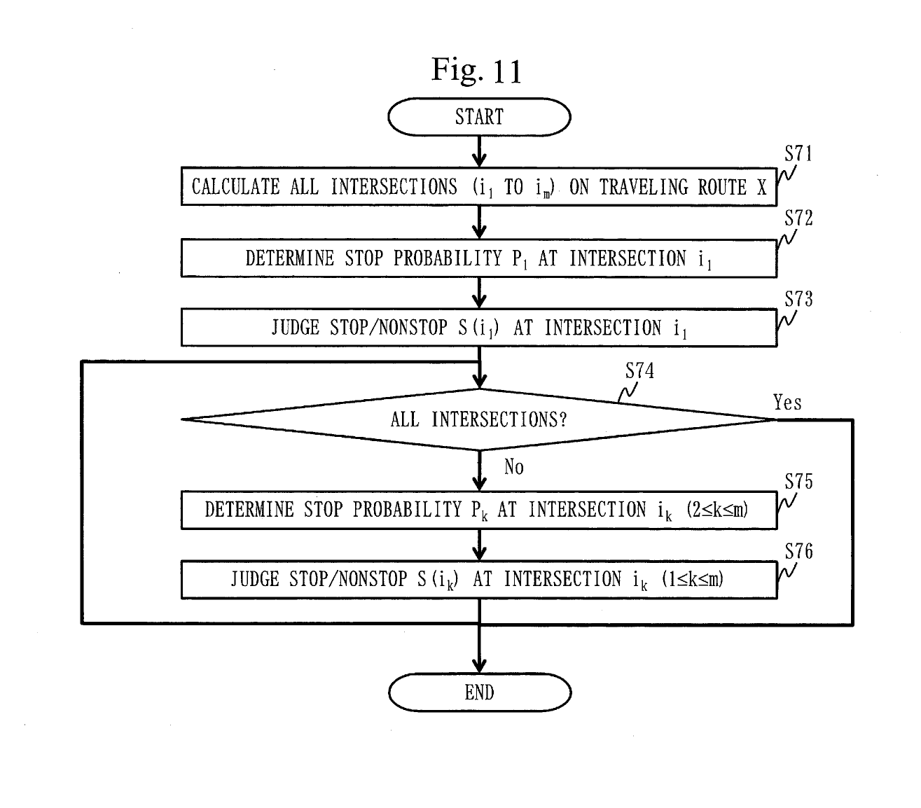

FIG. 11 is a flowchart of operation of the stop judgment unit 244 according to the present embodiment. FIG. 11 illustrates details of the process of step S54 of FIG. 9.

At step S71, the stop judgment unit 244 calculates all intersections (i₁ to iₘ) on the traveling route X calculated by the traveling route calculation unit 241. Here, in calculating all intersections on the traveling route, the stop judgment unit 244 performs extraction based on the cartographic information 450, and takes the intersections as i₁, i₂, . . . iₘ in the order of passing.

At step S72, the stop judgment unit 244 determines a stop probability P₁ at the intersection i₁ to be passed first on the traveling route X. Here, the stop judgment unit 244 extracts, as the stop probability P₁, a stop probability at a passage date and time of passing the intersection i₁ from the stop probability DB 252. Here, as for the date and time of passing the intersection i₁, a time of inflow to the link L₂ calculated at the traveling velocity extraction unit 242 (time t₂, day of the week w₂, season s₂) is the date and time of passing the intersection i₁. That is, when the date and time of passing the intersection i₁ is a time t′₁, day of the week w′₁, and season s′₁, (t′₁=t₂, w′₁=w₂, s′₁=s₂) holds. The stop judgment unit 244 extracts a stop probability P(i₁, t′₁, w′₁, s′₁) from the stop probability DB 252 as a stop probability at the intersection i₁, and determines it as a stop probability P₁ at the intersection i₁.

At step S73, the stop judgment unit 244 judges a stop/nonstop S(i₁) of the intersection i₁. For the stop/nonstop S(i₁) of the intersection i₁, a judgment is made by using P₁ as in the following expression (4).

$$\begin{matrix}FORMULA 4 & \\ S ( {i}_{1} ) = \{ \begin{matrix}stop & ( P \vert {P}_{1} ) \\ pass & ( P \vert 1 - {P}_{1} )\end{matrix} ( {P}_{1} = P ( {i}_{1} , {t}_{1}^{′} , {w}_{1}^{′} , {s}_{1}^{′} ) ) & ( 4 )\end{matrix}$$

At step S74, the stop judgment unit 244 judges whether stop judgments have been completed for all intersections. If stop judgments have been completed for all intersections, that is, when k=m as for k representing the number of intersections, the process ends. On the other hand, if stop judgments have not been completed for all intersections, that is, when k<m, the process proceeds to step S75.

At step S75, the stop judgment unit 244 determines a stop probability Pₖ for an intersection iₖ (2≤k≤m). The stop judgment unit 244 extracts a stop probability at the date and time of passing the intersection iₖ from the stop probability DB 252, and takes it as the stop probability Pₖ. The passage date and time of passing the intersection iₖ is a time of inflow to the link Lₖ₊₁ (time t_{k+1,} day of the week wₖ₊₁, season sₖ₊₁) calculated by the traveling velocity extraction unit 242. Therefore, when the passage date and time of the intersection iₖ is taken as time t′ₖ, day of the week w′ₖ, and season s′ₖ, (t′ₖ=tₖ₊₁, w′ₖ=wₖ₊₁, s′ₖ=sₖ₊₁) holds. The stop judgment unit 244 extracts a stop probability P(iₖ, t′ₖ, w′ₖ, s′ₖ) from the stop probability DB 252 as a stop probability at the intersection iₖ, and determines it as the stop probability Pₖ at the intersection iₖ.

At step S76, the stop judgment unit 244 judges a stop/nonstop S(iₖ) for the intersection iₖ. First, the stop judgment unit 244 calculates a stop probability P′(iₖ) in consideration of the connection information for the intersection iₖ and an intersection iₖ₋₁. Here, to calculate the stop probability P′(iₖ) in consideration of the connection information for the intersection iₖ and the intersection iₖ₋₁, the connection information A(iₖ, t′ₖ, w′ₖ, s′ₖ) for the intersection iₖ stored in the connection DB 253, the stop probability P(iₖ, t′ₖ, s′ₖ) at the intersection iₖ stored in the stop probability DB 252, and a stop probability Pₖ₋₁ at the intersection iₖ₋₁ calculated in a previous process are used to perform calculation as in an expression (5).

$$\begin{matrix} FORMULA 5 & \\ {P}_{k} = A ( {i}_{k} , {t}_{k}^{′} , {w}_{k}^{′} , {s}_{k}^{′} ) ( \begin{matrix}P ( {i}_{k} , {t}_{k}^{′} , {w}_{k}^{′} , {s}^{′} ) \\ ⋮ \\ 0 \\ {P}_{k - 1} \\ ⋮ \\ 0\end{matrix} ) + ( 1 - A ( {i}_{k} , {t}_{k}^{′} , {w}_{k}^{′} , {s}_{k}^{′} ) ( \begin{matrix}0 \\ ⋮ \\ 0 \\ ⋮ \\ 1 \\ ⋮ \\ 0\end{matrix} ) ) P ( {i}_{k} , {t}_{k}^{′} , {w}_{k}^{′} , {s}^{′} ) & ( 5 )\end{matrix}$$

In the expression (5), if the intersection iₖ and the intersection iₖ₋₁ are connectively operated, the stop probability Pₖ is a sum of Pₖ₋₁ and Pₖ(iₖ, t′ₖ, w′ₖ, s′ₖ) in consideration of the degree of connection with the intersection iₖ₋₁. If the intersection iₖ and the intersection iₖ₋₁ are not connectively operated, the result is acquired such that the stop probability Pₖ is still P(iₖ, W′ₖ, S′ₖ).

The stop judgment unit 244 uses the stop probability Pₖ in consideration of the connection information calculated by the expression (5) to judge the stop/nonstop S(ᵢₖ) for the intersection iₖ as in the expression (6).

$$\begin{matrix}FORMULA 6 & \\ S ( {i}_{k} ) = \{ \begin{matrix}stop & ( P \vert {P}_{k} ) \\ pass & ( P \vert 1 - {P}_{k} )\end{matrix} & ( 6 )\end{matrix}$$

After the process at step S76 ends, the process returns to step S74.

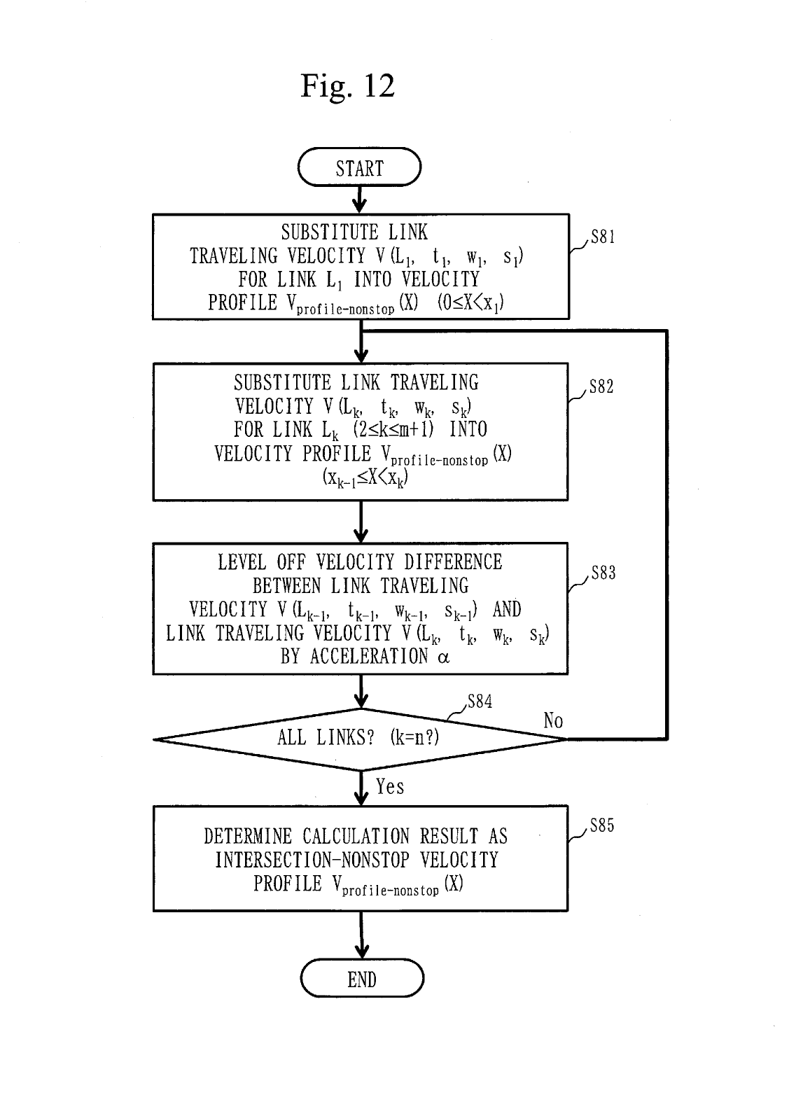

FIG. 12 is a flowchart of operation of the velocity profile generation unit 245 according to the present embodiment. FIG. 12 illustrates details of the process at step S55 of FIG. 9.

At step S81, the velocity profile generation unit 245 substitutes the link traveling velocity V(L₁, t₁, w₁, s₁) for the link L₁ into 0≤X≤x₁ of the velocity profile V_{profile-nonstop}(X). Here, x₁ indicates a cumulative value of the traveling distance to the link L₁, that is, x₁=X₁.

Next at step S82, the velocity profile generation unit 245 substitutes the link traveling velocity V(Lₖ, tₖ, wₖ, sₖ) for the link Lₖ (2≤k≤m+1) into xₖ₋₁≤X≤xₖ of the velocity profile V_{profile-nonstop}(X). Here, xₖ indicates a cumulative value of the traveling distance to the link Lₖ, that is, xₖ=X₁+X₂+ . . . +Xₖ.

Next at step S83, the velocity profile generation unit 245 performs process of leveling off a velocity difference between the link traveling velocity V(Lₖ₋₁, tₖ₋₁, wₖ₋₁, sₖ₋₁) occurring at a position xₖ₋₁ from the starting position of the traveling route X, that is, V_{profile-nonstop}(xₖ₋₁), and the link traveling velocity V(Lₖ, tₖ, wₖ, sₖ), by an acceleration α. Here, the acceleration α is set in advance by an administrator of the fuel efficiency estimation device 200. In setting the acceleration α, setting is appropriately performed in consideration of a general change in acceleration/deceleration at the time of motor-vehicle traveling.

Next at step S84, the velocity profile generation unit 245 judges whether substitutions of the link traveling velocity into the velocity profile V_{profile-nonstop}(X) have been completed for all links. If the processes for all links have been completed, the process proceeds to step S85. If the processes for all links have not been completed, the process returns to step S82.

When judging that the processes for all links have been completed in the process at step S85, the velocity profile generation unit 245 determines the velocity profile V_{profile-nonstop}(X) as an intersection-nonstop velocity profile at step S85.

The processes from step S81 to step S85 are organized as in an expression (7).

$$\begin{matrix}FORMULA 7 & \\ {V}_{profile \text{-} nonstop} ( X ) = \{ \begin{matrix}V ( {L}_{1} , {t}_{1} , {w}_{1} , {s}_{1} ) & ( 0 \leq X < {x}_{1} ) \\ V ( {L}_{2} , {t}_{2} , {w}_{2} , {s}_{2} ) & ( {x}_{1} \leq X < {x}_{2} ) \\ ⋮ & \\ V ( {L}_{n} , {t}_{n} , {w}_{n} , {s}_{n} ) & ( {x}_{n - 1} \leq X \leq {x}_{n} )\end{matrix} & ( 7 )\end{matrix}$$

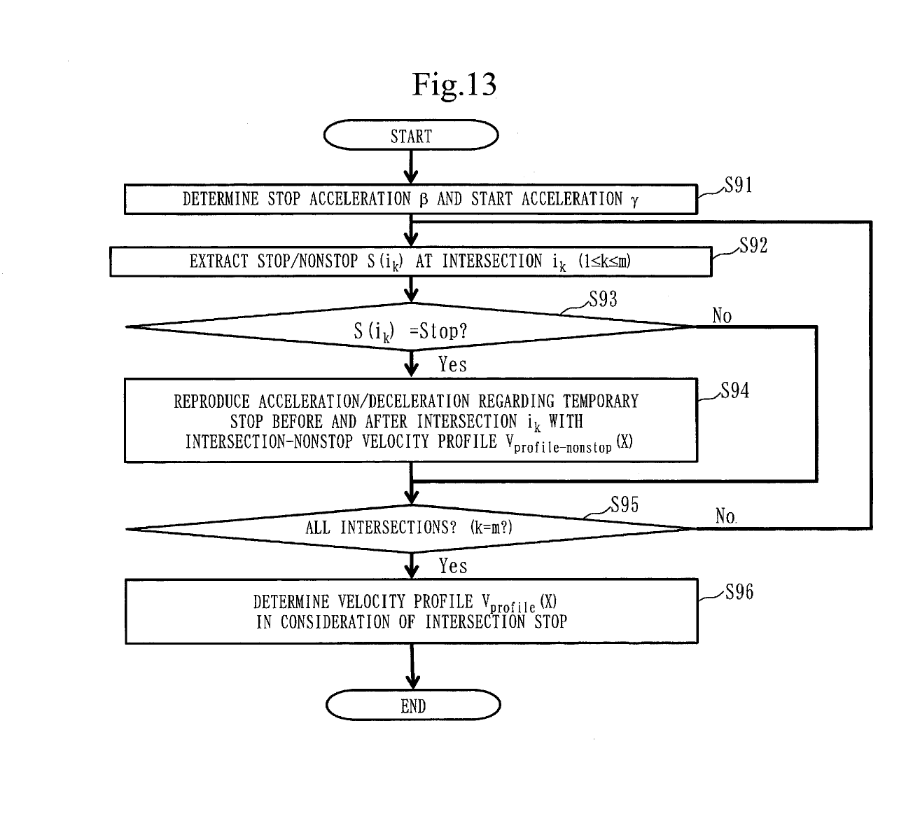

FIG. 13 is a flowchart of operation of the velocity correction unit 246 according to the present embodiment. FIG. 13 illustrates details of the process at step S56 of FIG. 9.

First at step S91, the velocity correction unit 246 determines an acceleration β for stopping and an acceleration γ for starting moving at intersection stop. Here, in determining the acceleration β and the acceleration γ, they are appropriately set in consideration of a change in acceleration/deceleration for a general stop and start at the time of motor-vehicle traveling.

Next at step S92, the velocity correction unit 246 extracts a stop/nonstop S(iₖ) at the intersection iₖ (1≤k≤m).

Next at step S93, in traveling the traveling route X, the velocity correction unit 246 judges, based on the stop/nonstop S(iₖ), whether the motor vehicle stops at the intersection iₖ. When a stop is made at the intersection iₖ (S(iₖ)=Stop), the process proceeds to step S94. On the other hand, when a stop is not made at the intersection iₖ (S(iₖ)=Pass), the process proceeds to step S95.

At step S94, when a stop is made at the intersection iₖ, the velocity correction unit 246 reproduces acceleration/deceleration regarding a temporary stop before and after the intersection iₖ with the intersection-nonstop velocity profile V_{profile-nonstop}(X). As reproduction of acceleration/deceleration, the velocity correction unit 246 calculates a change in velocity based on the stop acceleration β and the start acceleration γ determined at step S91 so that the velocity becomes 0 at a position of the intersection iₖ. V_{profile-nonstop}(X) is overwritten with the calculation result.

Next at step S95, the velocity correction unit 246 judges whether judgments regarding intersection stop/nonstop and acceleration/deceleration reproduction regarding intersection stop have been completed for all intersections. If the processes for all intersections have been completed, the process proceeds to step S96. If the processes for all intersections have not been completed, the process returns to step S92.

If the processes for all intersections have been completed, at step S96, the velocity correction unit 246 determines V_{profile-nonstop}(X) overwritten with the result of acceleration/deceleration reproduction based on intersection stop/nonstop as the velocity profile V_{profile}(X) in consideration of intersection stop.

And, as described above, at step S57 of FIG. 9, the fuel efficiency calculation unit 247 estimates traveling fuel efficiency in traveling the traveling route X by using the velocity profile V_{profile}(X) calculated by the velocity correction unit 246. The fuel efficiency calculation unit 247 outputs the estimated fuel efficiency estimation result 461 to the information transmission unit 22. The information transmission unit 22 transmits the fuel efficiency estimation result 461 to the motor vehicle device 100 mounted on the motor vehicle 1.

***Other Structures***

Also in the present embodiment, each function of the motor vehicle device 100 and the fuel efficiency estimation device 200 is implemented by software. As a modification example, each function of the motor vehicle device 100 and the fuel efficiency estimation device 200 may be implemented by hardware.

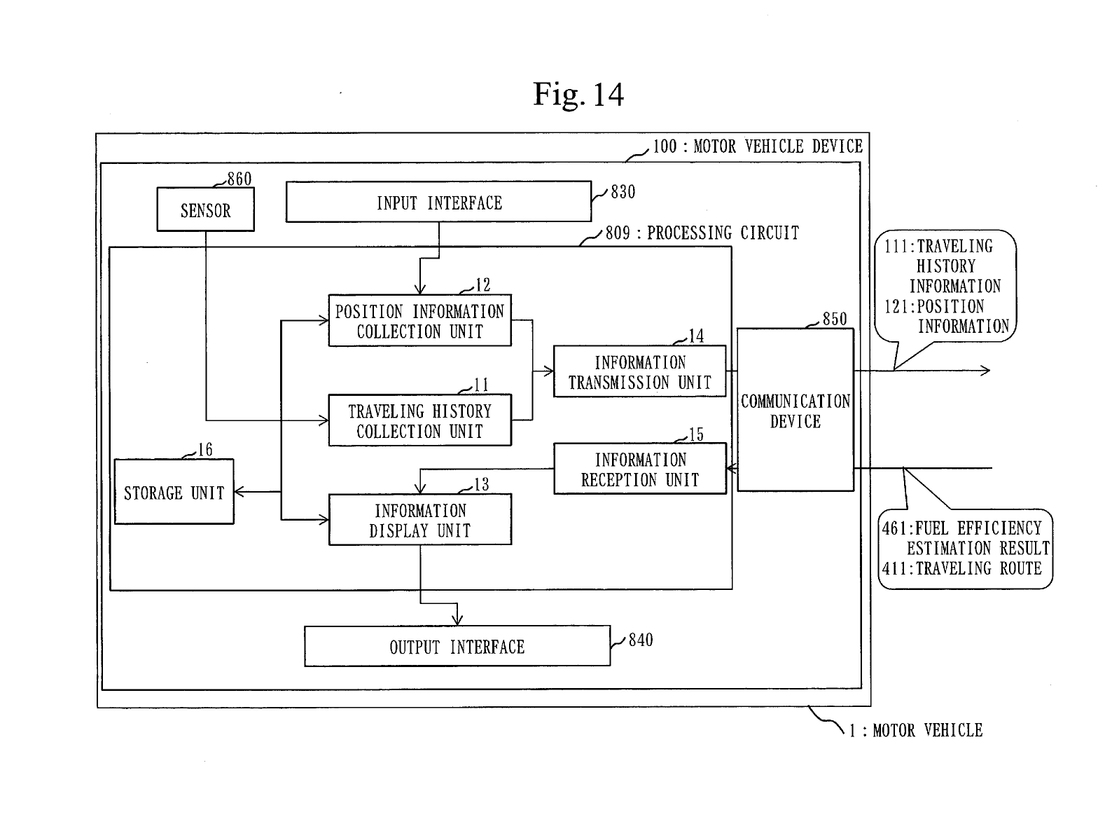

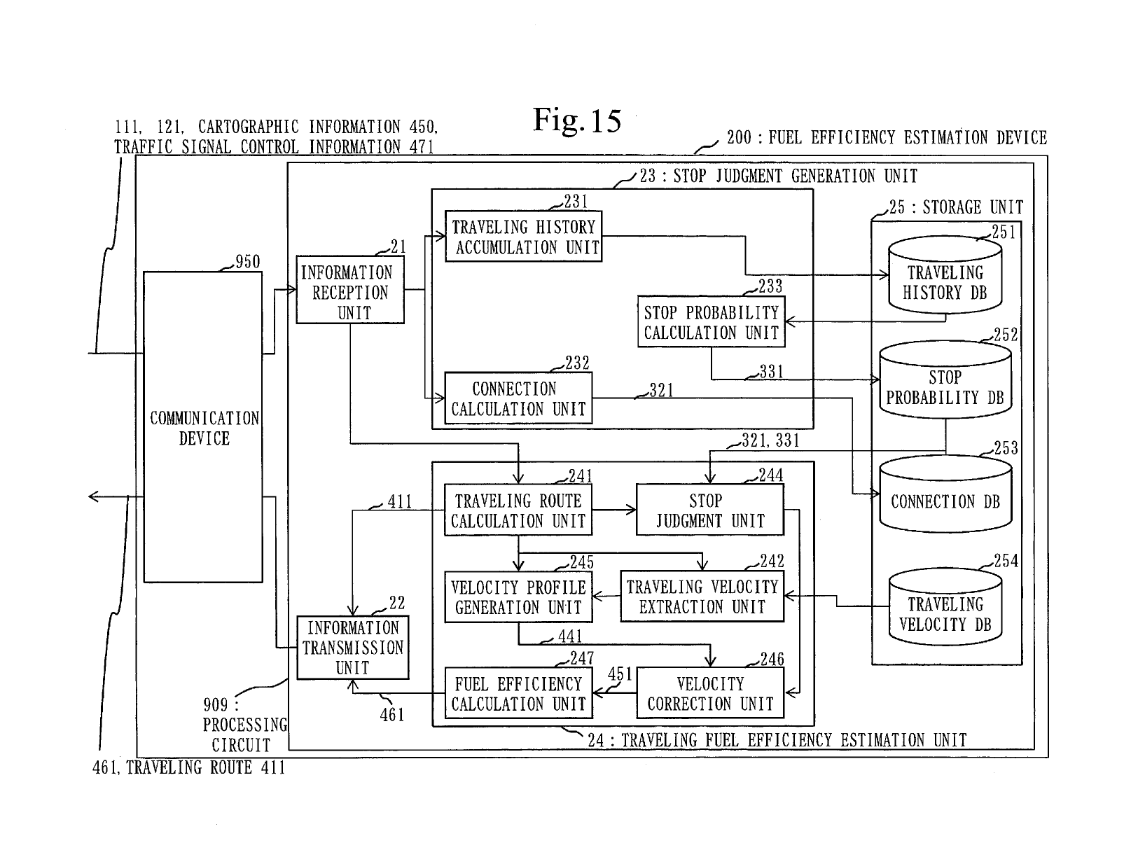

FIG. 14 illustrates a structure of the motor vehicle device 100 according to a modification example of the present embodiment. Also, FIG. 15 illustrates a structure of the fuel efficiency estimation device 200 according to a modification example of the present embodiment.

As illustrated in FIG. 14 and FIG. 15, each of the motor vehicle device 100 and the fuel efficiency estimation device 200 includes hardware such as processing circuit 809, 909, the input interface 830, the output interface 840, and the communication device 850, 950.

The processing circuit 809, 909 is a dedicated electronic circuit for achieving the functions of the “units” and the storage unit described above. The processing circuit 809, 909 is specifically a single circuit, composite circuit, programmed processor, parallel programmed processor, logic IC, GA (Gate Array), ASIC (Application Specific Integrated Circuit), or FPGA (Field-Programmable Gate Array).

Each of the motor vehicle device 100 and the fuel efficiency estimation device 200 may include a plurality of processing circuits replacing the processing circuit 809, 909. The plurality of these processing circuits achieve the functions of the “units” as a whole. Each of these processing circuits is a dedicated electronic circuit, like the processing circuit 809, 909.

As another modification example, each function of the motor vehicle device 100 and the fuel efficiency estimation device 200 may be implemented by a combination of software and hardware. That is, part of the functions of each of the motor vehicle device 100 and the fuel efficiency estimation device 200 may be implemented by dedicated hardware, and the remaining functions may be implemented by software.

The processor 810, 910, the storage device 820, 920, and the processing circuit 809, 909 are collectively referred to as “processing circuitry”. That is, if the structure of each of the motor vehicle device 100 and the fuel efficiency estimation device 200 is any of those illustrated in FIGS. 2, 3, 14, and 15, the functions of the “units” and the storage unit are achieved by the processing circuitry.

The “units” may be read as “steps”, “procedures”, or “processes”. Also, the functions of the “units” may be achieved by firmware.

***Description of Effects of Present Embodiment***

The fuel efficiency estimation system 500 according to the present embodiment includes a stop judgment generation unit which calculates a stop probability for each intersection on the road and connection information of traffic signals with an adjacent intersection as for fuel efficiency estimation in motor vehicle traveling. Also, the fuel efficiency estimation system 500 includes a traveling fuel efficiency estimation unit which calculates a velocity profile indicating a velocity change situation at the time of traveling in consideration of intersection stop for a specific traveling route and estimates traveling fuel efficiency. Furthermore, the fuel efficiency estimation system 500 calculates the connection information of the traffic signals by using cartographic information and traffic signal control information as infrastructure information. Thus, according to the fuel efficiency estimation system 500 of the present embodiment, an intersection stop judgment can be made also in consideration of traffic signal connection control, and therefore motor-vehicle traveling fuel efficiency can be estimated with higher accuracy.

The fuel efficiency estimation system 500 according to the present embodiment calculates, as connection information of the traffic signal at each intersection, connected/disconnected operation with adjacent intersections and information as to whether no traffic signal is present or traffic signal control is independent from all adjacent intersections. Also, the fuel efficiency estimation system 500 can make divisions at least by time (for example, thirty-minute intervals), day of the week, and season (for example, one-month intervals) as date and time division units, and can hold the connection information at the relevant date and time as vector information.

The fuel efficiency estimation system 500 according to the present embodiment calculates a stop probability at an intersection by using traveling history information collected from the motor vehicle and the cartographic information. Also, the fuel efficiency estimation system 500 can make divisions at least by time (for example, thirty-minute intervals), day of the week, and season (for example, one-month intervals) as date and time division units, and can statistically calculate a stop probability at the relevant date and time.

As for traveling fuel efficiency estimation, the fuel efficiency estimation system 500 according to the present embodiment extracts and couples link traveling velocities for a specific traveling route in consideration of passage times of all passage links. This can reproduce a velocity profile in accordance with a date and time when fuel efficiency estimation is desired to be made.

As for traveling fuel efficiency estimation, the fuel efficiency estimation system 500 according to the present embodiment judges stop/nonstop at all passage intersections for a specific traveling route, and reproduces acceleration/deceleration by intersection stop, thereby allowing an improvement in calculation accuracy of the velocity profile.

As for traveling fuel efficiency estimation, the fuel efficiency estimation system 500 according to the present embodiment can estimate motor-vehicle traveling fuel efficiency by a relational expression of traveling fuel efficiency and traveling velocity from the velocity profile in consideration of intersection stop.

As described above, according to the fuel efficiency estimation system 500 of the present embodiment, as for traveling fuel efficiency estimation, by stop probability calculation based on the traveling history information and utilization of the connection information acquired from the infrastructure information, a judgment is made as to intersection stop including connection control of traffic signals. This improves accuracy of intersection stop judgment and can achieve traveling fuel efficiency estimation with high accuracy.

### Embodiment 2

In the present embodiment, differences from Embodiment 1 are mainly described.

In the present embodiment, a structure similar to the structure described in Embodiment 1 is provided with a same reference character, and its description is omitted.

***Description of Structure***

The fuel efficiency estimation system 500 according to Embodiment 1 includes the motor vehicle device 100 mounted on the motor vehicle 1 and the fuel efficiency estimation device 200 implemented by a central server in the cloud or the like.

The motor vehicle device 100 collects the traveling history information 111, and requests the fuel efficiency estimation device 200 to calculate traveling fuel efficiency of the motor vehicle 1. The fuel efficiency estimation device 200 calculates the velocity profile 451 based on the stop/nonstop at the intersection in consideration of traffic signal connection control and calculates traveling fuel efficiency of the motor vehicle 1.

In the present embodiment, a fuel efficiency estimation system 500a is described which estimates traveling fuel efficiency for each motor vehicle by calculating the velocity profile 451 based on intersection stop/nonstop in consideration of traffic signal connection control for each motor vehicle and calculating traveling fuel efficiency of the motor vehicle 1.

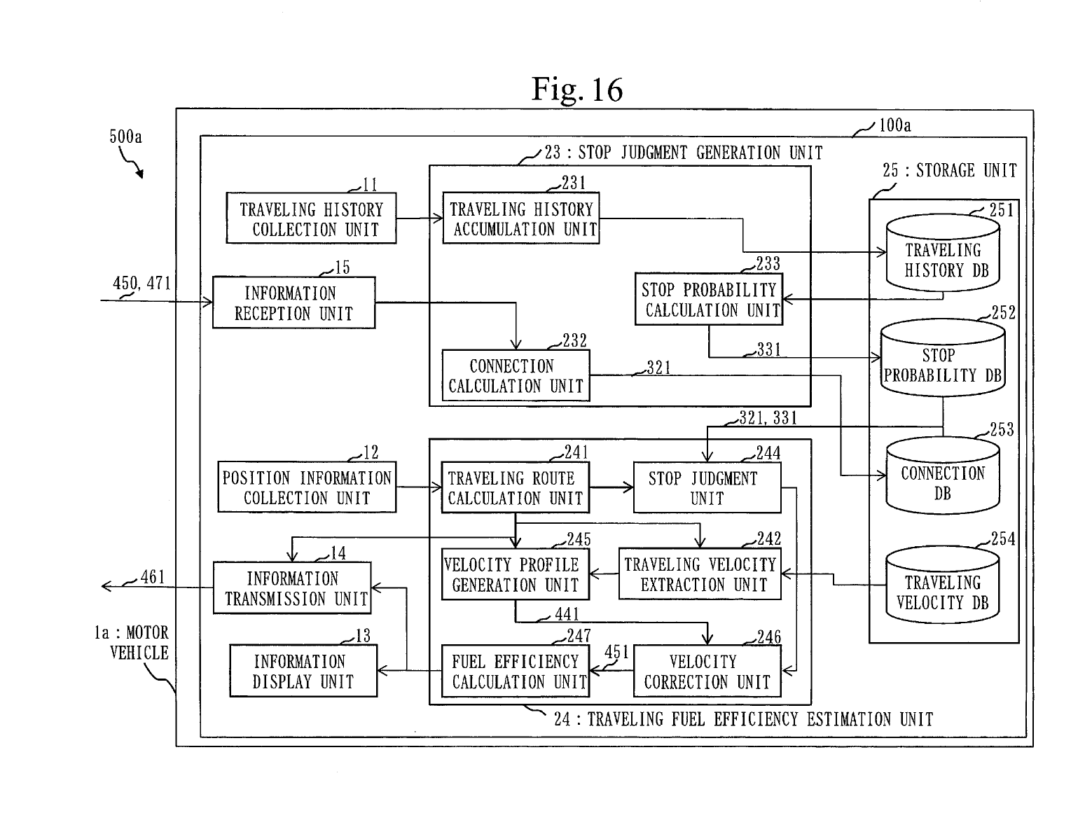

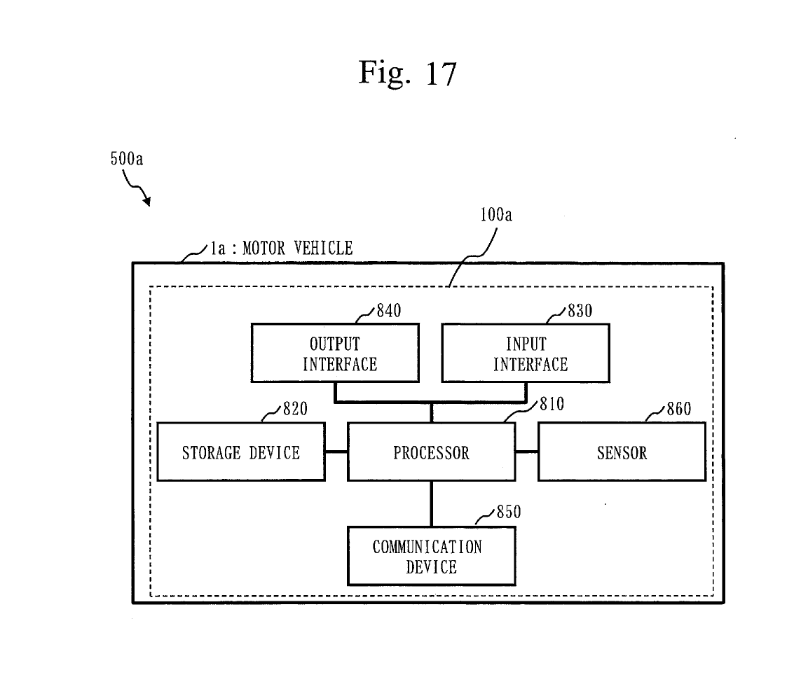

FIG. 16 illustrates a functional structure of the fuel efficiency estimation system 500a according to the present embodiment. Also, FIG. 17 illustrates a hardware structure of the fuel efficiency estimation system 500a according to the present embodiment.

In the present embodiment, the functional structure diagram and the hardware structure diagram of the fuel efficiency estimation system 500a are described as separate diagrams. However, a structure similar to the structure described in Embodiment 1 is provided with a same reference character and its description may be omitted.

The fuel efficiency estimation system 500a according to the present embodiment is configured only of a motor vehicle device 100a mounted on a motor vehicle 1a.

The motor vehicle device 100a of the motor vehicle 1a includes, as functional structures, the traveling history collection unit 11, the position information collection unit 12, the information display unit 13, the information transmission unit 14, the information reception unit 15, the stop judgment generation unit 23, and the traveling fuel efficiency estimation unit 24.

The functional structure of each of the traveling history collection unit 11, the position information collection unit 12, the information display unit 13, the information transmission unit 14, and the information reception unit 15 is similar to the functional structure of the motor vehicle device 100 of Embodiment 1.

Also, the functional structure of each of the stop judgment generation unit 23 and the traveling fuel efficiency estimation unit 24 is similar to the functional structure of the fuel efficiency estimation device 200 of Embodiment 1.

***Description of Functional Structure***

Next, in the respective functional structures of the motor vehicle device 100a of the motor vehicle 1a, differences from Embodiment 1 are described.

The traveling history collection unit 11 outputs the traveling history information 111 collected by using the sensor 860 directly to the traveling history accumulation unit 231 of the stop judgment generation unit 23. The traveling history accumulation unit 231 directly acquires the traveling history information 111 from the traveling history collection unit 11.

The position information collection unit 12 outputs the position information 121 inputted via the input interface 830 directly to the traveling route calculation unit 241 of the traveling fuel efficiency estimation unit 24. The traveling route calculation unit 241 directly acquires the position information 121 from the position information collection unit 12.

As described above, the motor vehicle 1a has the functional structure of the motor vehicle device 100 and the functional structure of the fuel efficiency estimation device 200 described in Embodiment 1. The traveling history collection unit 11, the position information collection unit 12, the information display unit 13, the information transmission unit 14, and the information reception unit 15 correspond to the functions of the motor vehicle device 100. Also, the stop judgment generation unit 23 and the traveling fuel efficiency estimation unit 24 correspond to the functional structure of the fuel efficiency estimation device 200.

Note that the functions of the information reception unit 21 and the information transmission unit 22 of the fuel efficiency estimation device 200 described in Embodiment 1 are assumed to be included in the functions of the information transmission unit 14 and the information reception unit 15 of the motor vehicle device 100a described above. Also, the function of the storage unit 16 of the motor vehicle device 100 described in Embodiment 1 is assumed to be included in the function of the storage unit 25 of the motor vehicle device 100a described above.

Next, as for the hardware structure of the motor vehicle device 100a of the motor vehicle 1a configuring the fuel efficiency estimation system 500a, differences from Embodiment 1 are described.

The processor 810 performs processes of the motor vehicle device 100a, such as an instruction for displaying various types of information to be displayed on the display, a process of collecting the traveling history information 111 and the position information 121, a process of accumulating the traveling history information 111, a process of calculating connection information 321, a process of calculating the stop probability 331 at an intersection, a process of calculating a velocity profile, and a process of estimating traveling fuel efficiency.

Also, the storage device 820 achieves the functions of the storage unit 16 and the storage unit 25 described in Embodiment 1.

Furthermore, the communication device 850 achieves the functions of the information transmission unit 14 and the information reception unit 15 and the functions of the information transmission unit 22 and the information reception unit 21 described in Embodiment 1.

As described above, the fuel efficiency estimation system 500a includes the motor vehicle device 100a mounted on the motor vehicle 1a as a fuel efficiency estimation target. The motor vehicle device 100a includes at least the traveling route calculation unit 241, the traveling history collection unit 11, the traveling history accumulation unit 231, the stop probability calculation unit 233, the connection calculation unit 232, the velocity profile generation unit 245, the stop judgment unit 244, the velocity correction unit 246, and the fuel efficiency calculation unit 247.

Next, operation is described.

Embodiment 2 is different from Embodiment 1 in that the stop judgment generation unit 23 and the traveling fuel efficiency estimation unit 24 are mounted on the motor vehicle 1a. However, as for the operation of each unit, the stop judgment generation unit 23 in Embodiment 1 and the stop judgment generation unit 23 in Embodiment 2 perform similar operations, and the traveling fuel efficiency estimation unit 24 in Embodiment 1 and the traveling fuel efficiency estimation unit 24 in Embodiment 2 perform similar operations. Detailed inner operations are also similar, and therefore description of operation is omitted.

***Other Structures***

In the present embodiment, the motor vehicle device 100a having the functions of the motor vehicle device 100 and the functions of the fuel efficiency estimation device 200 described in Embodiment 1 is mounted on the motor vehicle 1a. Here, while description has been made to the case in which the motor vehicle device 100a is a single computer in FIG. 16, the structure is not limited to the structure of FIG. 16. For example, the functions corresponding to the motor vehicle device 100 and the functions corresponding to the fuel efficiency estimation device 200 may be mounted on separate vehicle-mounted devices. Also, units included in the functions corresponding to the motor vehicle device 100 and the functions corresponding to the fuel efficiency estimation device 200 may be combined in any manner and be mounted on a plurality of vehicle-mounted devices.

***Description of Effects According to Present Embodiment***

As described above, according to the fuel efficiency estimation system 500a of the present embodiment, traveling history information is accumulated for each motor vehicle, connection information is calculated for each motor vehicle, and intersection stop probability is calculated for each motor vehicle, thereby estimating traveling fuel efficiency for each motor vehicle. Therefore, it is possible to estimate traveling fuel efficiency with high accuracy for each motor vehicle.

### Embodiment 3

In the present embodiment, differences from Embodiments 1 and 2 are mainly described.

In the present embodiment, a structure similar to the structure described in Embodiments 1 and 2 is provided with a same reference character and its description is omitted.

***Description of Structure***

In the fuel efficiency estimation system 500 according to Embodiment 1, the process of collecting and transmitting the traveling history information and the process of collecting and transmitting the position information are performed at the motor vehicle device 100. Also, the traveling history accumulation process, the stop probability calculation process, the connection calculation process, and the traveling fuel efficiency estimation process are performed at the fuel efficiency estimation device 200 as a central server. Furthermore, in the fuel efficiency estimation system 500a according to Embodiment 2, the process of the motor vehicle device 100 and the process of the fuel efficiency estimation device 200 in Embodiment 1 are all converged into the motor vehicle device 100a of the motor vehicle 1a.

In the present embodiment, for process load distribution, a structure is taken in which separate servers are prepared for the traveling history accumulation process, the stop probability calculation process, the connection calculation process, and the traveling fuel efficiency estimation process, respectively, among the processes of the fuel efficiency estimation device 200 for performing the processes. This allows a reduction in the amount of processing at each server, thereby making it possible to increase the processing speed. Note that the processes to be performed on a motor vehicle side are identical to those of Embodiment 1.

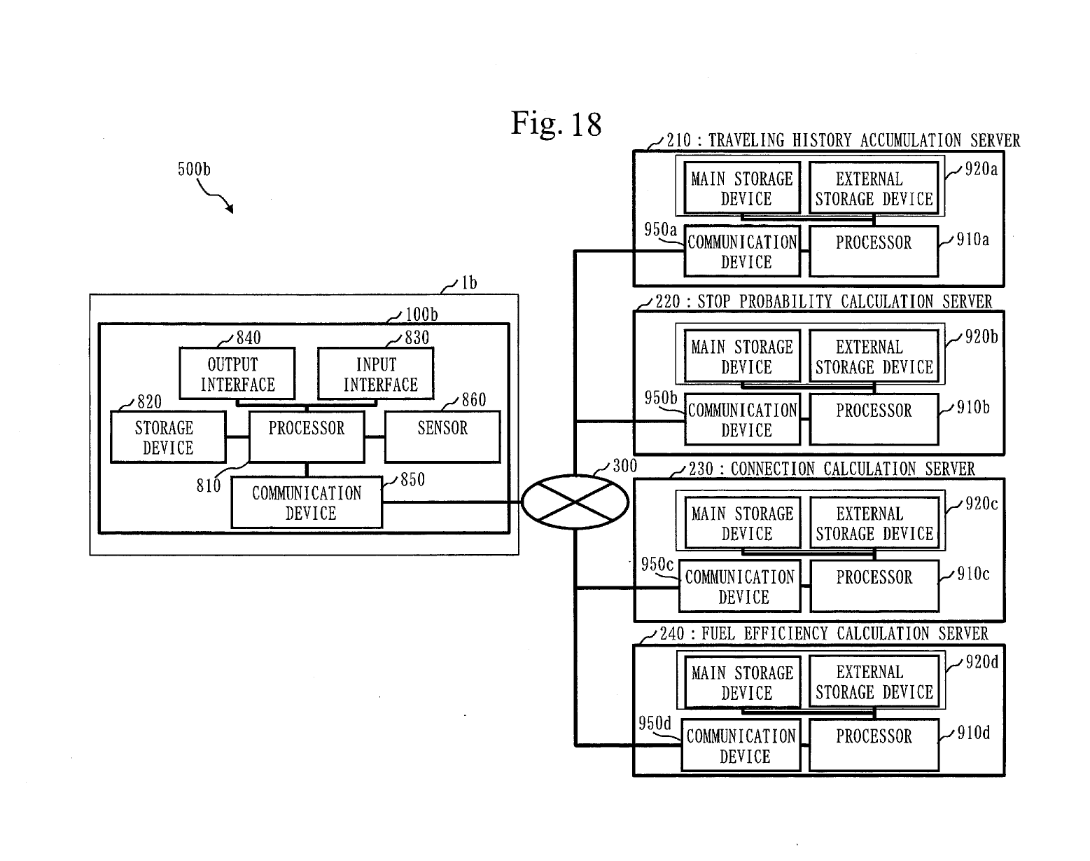

FIG. 18 illustrates a system structure of a fuel efficiency estimation system 500b according to the present embodiment. FIG. 18 illustrates a hardware structure of each device configuring the fuel efficiency estimation system 500b.

As illustrated in FIG. 18, the fuel efficiency estimation system 500b includes a motor vehicle 1b, a traveling history accumulation server 210, a stop probability calculation server 220, a connection calculation server 230, and a fuel efficiency calculation server 240. The motor vehicle 1b, the traveling history accumulation server 210, the stop probability calculation server 220, the connection calculation server 230, and the fuel efficiency calculation server 240 communicate via the network 300.

The traveling history accumulation server 210, the stop probability calculation server 220, the connection calculation server 230, and the fuel efficiency calculation server 240 each may be a substantial data server or may be configured in the cloud.

The hardware structure of the motor vehicle device 100b of the motor vehicle 1b is similar to that described in Embodiment 1.

Each of the traveling history accumulation server 210, the stop probability calculation server 220, the connection calculation server 230, and the fuel efficiency calculation server 240 is a computer.

The traveling history accumulation server 210, the stop probability calculation server 220, the connection calculation server 230, and the fuel efficiency calculation server 240 each include the processor 910, the storage device 920, and the communication device 950. Basic functions of the processor 910, the storage device 920, and the communication device 950 in each server are similar to those described in Embodiment 1. As illustrated in FIG. 18, the hardware pieces in each server are described as being distinguished with a subscript a, b, c, or d added to the reference numeral of each hardware piece.

The traveling history accumulation server 210 is described. A storage device 920a includes a main storage device which temporarily stores the process result regarding the traveling history accumulation process and an external storage device which stores the traveling history information. A processor 910a performs arithmetic operation process regarding the traveling history accumulation process. A communication device 950a transmits and receives the traveling history information 111 and the cartographic information 450.

The stop probability calculation server 220 is described. A storage device 920b includes a main storage device which temporarily stores the process result regarding calculation of the stop probability 331 at the intersection and an external storage device which stores the stop probability 331 at each intersection. A processor 910b performs arithmetic operation process regarding calculation of the stop probability 331 at the intersection. A communication device 950b transmits and receives the traveling history information 111 and the stop probability 331.

The connection calculation server 230 is described. A storage device 920c includes a main storage device which temporarily stores the process result regarding calculation of the connection information 321 and an external storage device which stores the connection information 321 of each intersection. A processor 910c performs arithmetic operation process regarding calculation of the connection information 321. A communication device 950c transmits and receives the cartographic information 450, the traffic signal control information 471, and the connection information 321.

The fuel efficiency calculation server 240 is described. A storage device 920d includes a main storage device which temporarily stores values and results of the respective arithmetic operation processes regarding fuel efficiency estimation. A processor 910d performs the respective arithmetic operation processes regarding fuel efficiency estimation. A communication device 950d transmits and receives the position information 121, the link traveling velocity, the cartographic information 450, and the fuel efficiency estimation result 461.

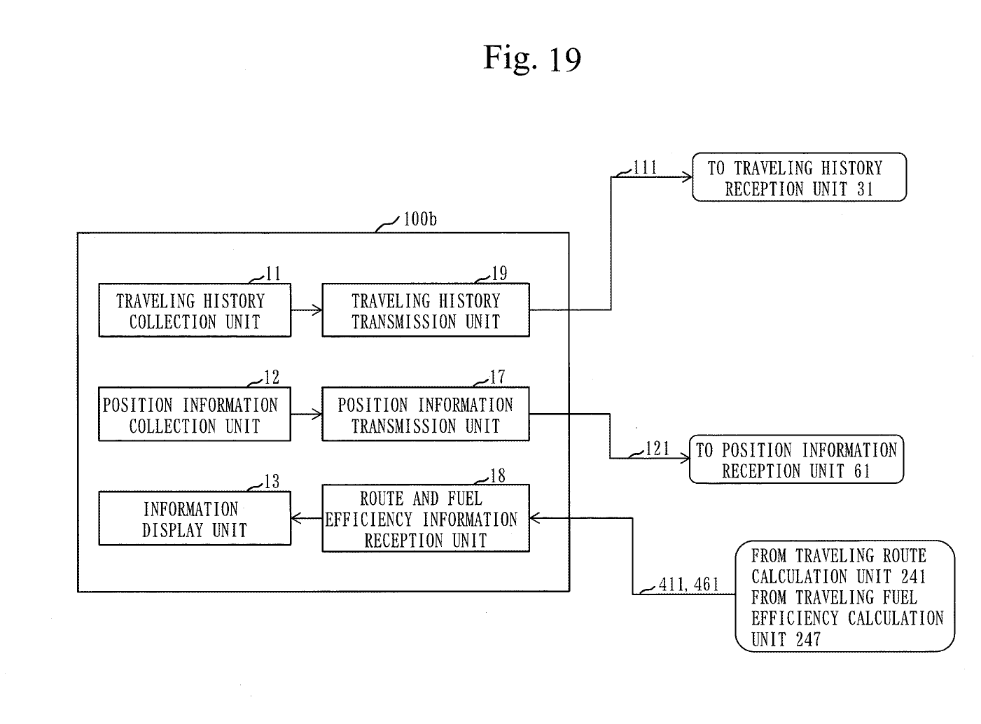

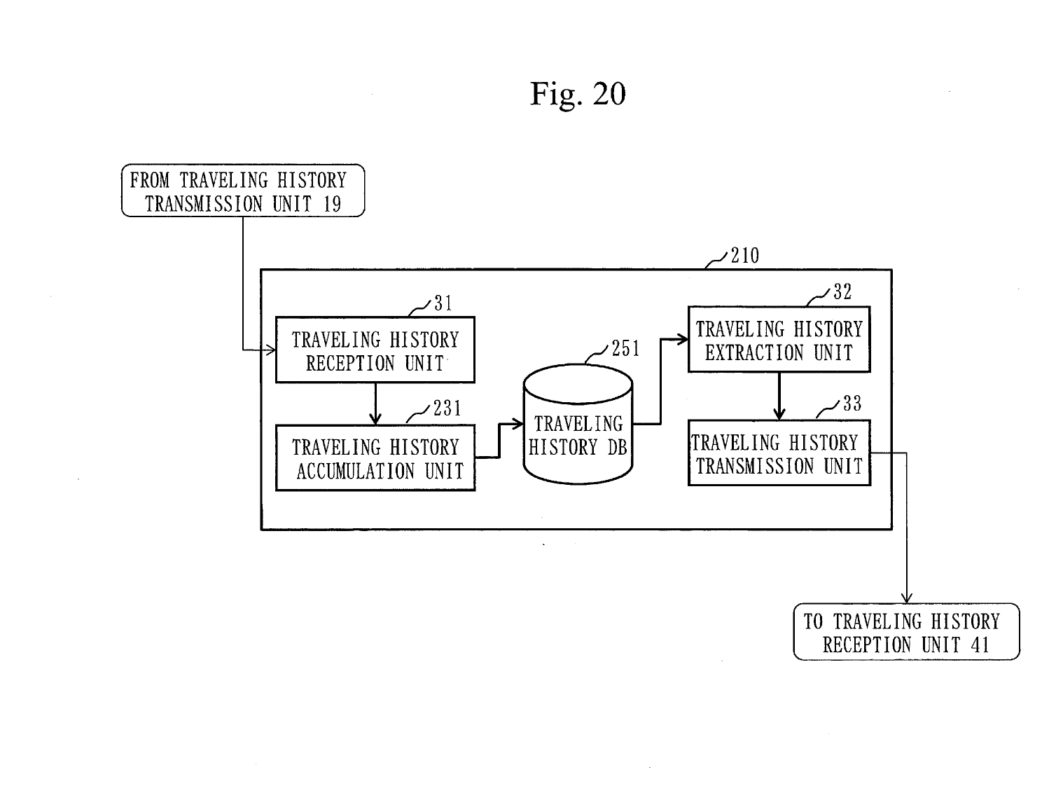

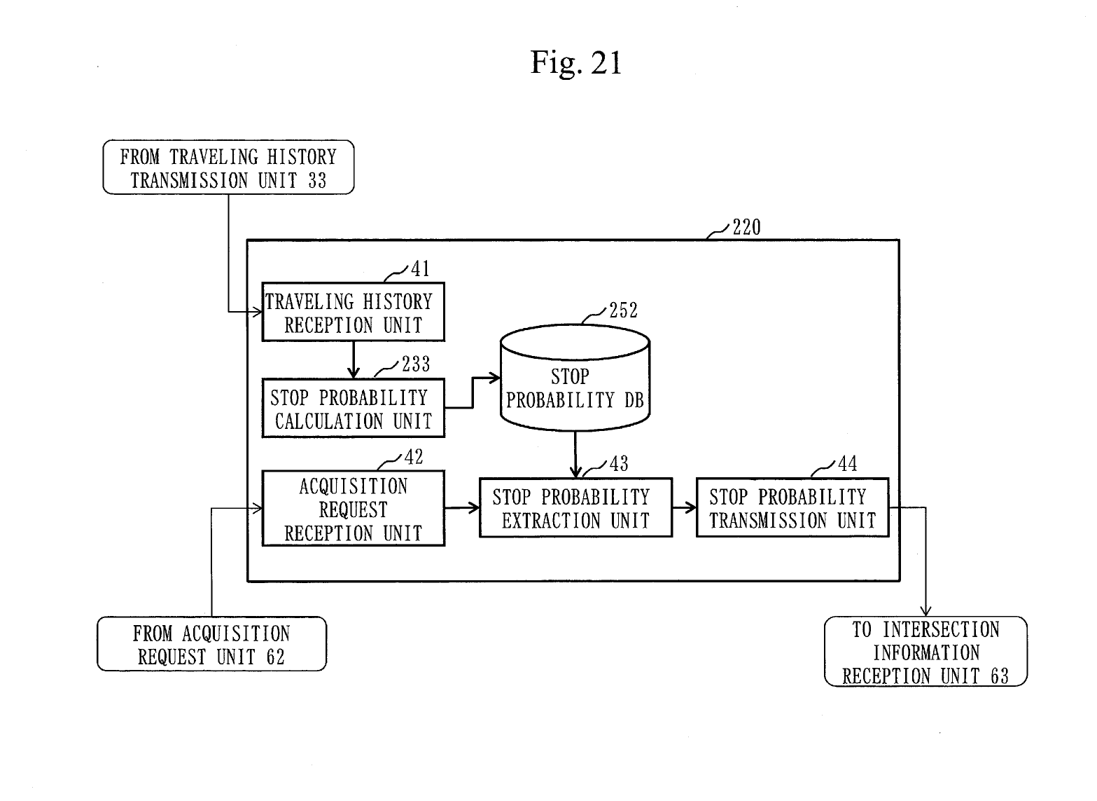

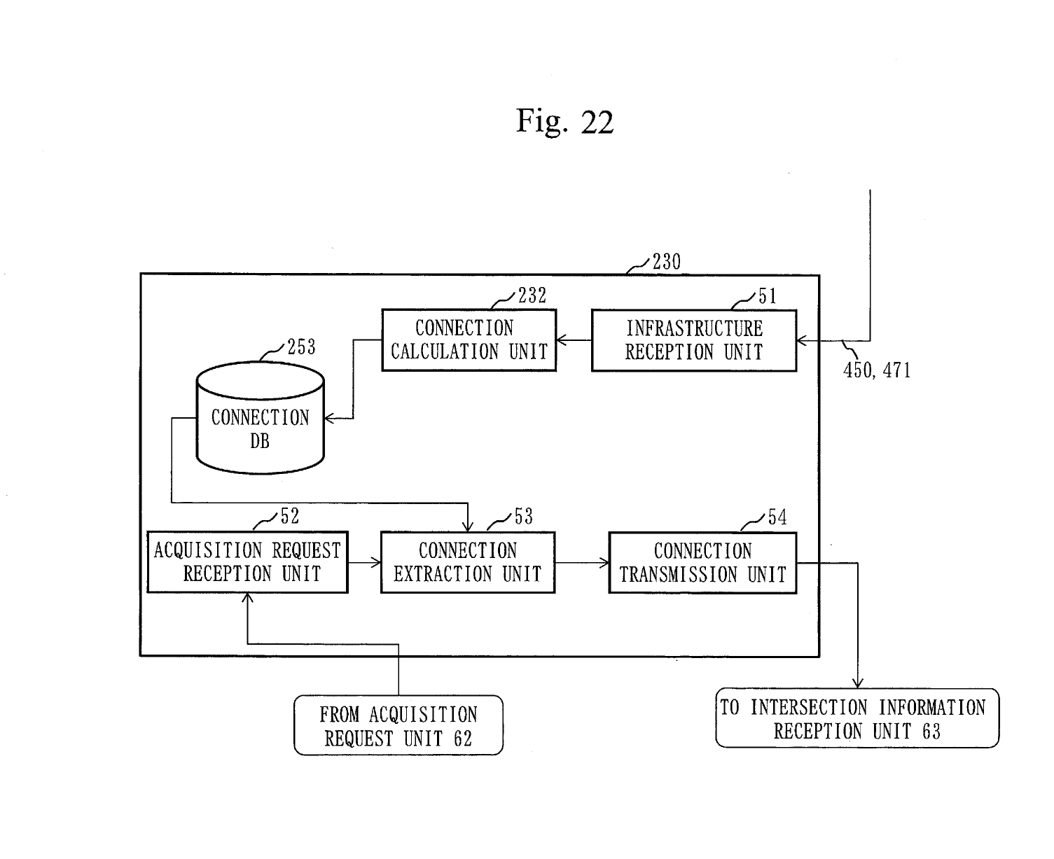

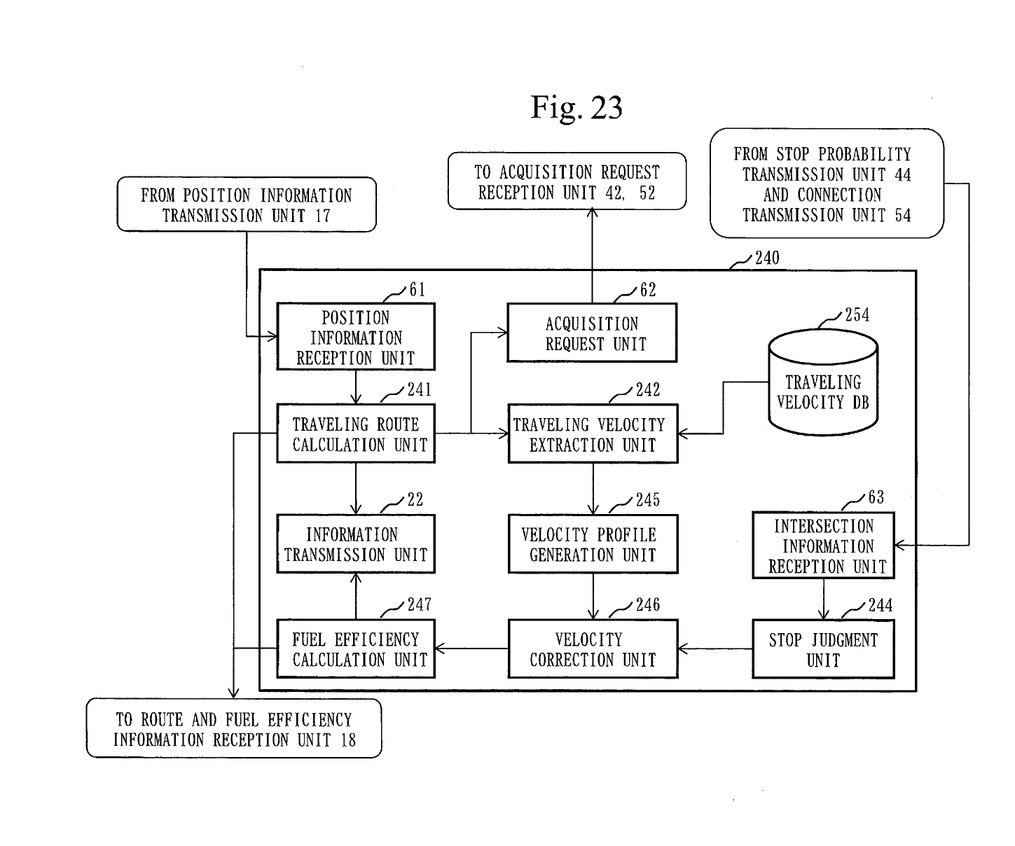

Also, FIG. 19 illustrates a functional structure of the motor vehicle device 100b according to the present embodiment. FIG. 20 illustrates a functional structure of the traveling history accumulation server 210 according to the present embodiment. FIG. 21 illustrates a functional structure of the stop probability calculation server 220 according to the present embodiment. FIG. 22 illustrates a functional structure of the connection calculation server 230 according to the present embodiment. FIG. 23 illustrates a functional structure of the fuel efficiency calculation server 240 according to the present embodiment.

In the present embodiment, the functional structure diagram and the hardware structure diagram of each device of the fuel efficiency estimation system 500b are described as separate diagrams. However, a structure similar to the structure described in Embodiment 1 is provided with a same reference character and its description may be omitted.

The motor vehicle 1b includes the motor vehicle device 100b mounted on the motor vehicle 1b as a vehicle-mounted device. The motor vehicle device 100b includes, in addition to the traveling history collection unit 11, the position information collection unit 12, and the information display unit 13 described in Embodiment 1, a traveling history transmission unit 19, a position information transmission unit 17, and a route and fuel efficiency information reception unit 18. That is, the functions of the “units” of the motor vehicle device 100b are the functions of the traveling history collection unit 11, the position information collection unit 12, the information display unit 13, the traveling history transmission unit 19, the position information transmission unit 17, and the route and fuel efficiency information reception unit 18.

The traveling history transmission unit 19 transmits the traveling history information 111 to the traveling history accumulation server 210 via the communication device 850. The position information transmission unit 17 transmits the position information 121 including the origin and the destination to the fuel efficiency calculation server 240 via the communication device 850. The traveling history transmission unit 19 and the position information transmission unit 17 are an example of an information transmission unit which transmits the position information 121 and the traveling history information 111 indicating traveling history of the motor vehicle 1b. The route and fuel efficiency information reception unit 18 receives, via the communication device 850, the traveling route 411 and the fuel efficiency estimation result 461 calculated by the fuel efficiency calculation server 240.

The traveling history accumulation server 210 includes, in addition to the traveling history accumulation unit 231 and the traveling history DB 251 described in Embodiment 1, a traveling history reception unit 31, a traveling history extraction unit 32, and a traveling history transmission unit 33. The traveling history reception unit 31 receives the traveling history information 111 transmitted from the motor vehicle 1b. The traveling history extraction unit 32 extracts necessary traveling history information 111 from the traveling history DB 251. The traveling history transmission unit 33 transmits the extracted traveling history information 111 to the stop probability calculation server 220. The functions of the other structure units are similar to those described in Embodiment 1.

The stop probability calculation server 220 includes, in addition to the stop probability calculation unit 233 and the stop probability DB 252 described in Embodiment 1, a traveling history reception unit 41, an acquisition request reception unit 42, a stop probability extraction unit 43, and a stop probability transmission unit 44. The traveling history reception unit 41 receives the traveling history information 111 from the traveling history accumulation server 210. The acquisition request reception unit 42 accepts a request for acquiring a stop probability from the fuel efficiency calculation server 240. The stop probability extraction unit 43 extracts, from the stop probability DB 252, the stop probability at an intersection requested for acquisition of stop probability. The stop probability transmission unit 44 transmits the extracted stop probability to the fuel efficiency calculation server 240. The functions of the other structure units are similar to those described in Embodiment 1.

The connection calculation server 230 includes, in addition to the connection calculation unit 232 and the connection DB 253 described in Embodiment 1, an infrastructure reception unit 51, an acquisition request reception unit 52, a connection extraction unit 53, and a connection transmission unit 54. The infrastructure reception unit 51 receives the cartographic information 450 and the traffic signal control information 471 as infrastructure information. The acquisition request reception unit 52 accepts a request for acquiring connection information from the fuel efficiency calculation server 240. The connection extraction unit 53 extracts, from the connection DB 253, the connection information of the intersection requested for acquisition. The connection transmission unit 54 transmits the extracted connection information to the fuel efficiency calculation server 240. The functions of the other structure units are similar to those described in Embodiment 1.

The fuel efficiency calculation server 240 includes the traveling route calculation unit 241, the traveling velocity extraction unit 242, the stop judgment unit 244, the velocity profile generation unit 245, the velocity correction unit 246, the fuel efficiency calculation unit 247, and the information transmission unit 22 described in Embodiment 1. Also, the fuel efficiency calculation server 240 includes, in addition to the above structure units, a position information reception unit 61, an acquisition request unit 62, and an intersection information reception unit 63. The position information reception unit 61 receives the position information 121 received from the motor vehicle 1b. The acquisition request unit 62 transmits a request for acquiring the stop probability to the stop probability calculation server 220 for all intersections on the traveling route 411 calculated by the traveling route calculation unit 241. Also, the acquisition request unit 62 transmits a request for acquiring connection information to the connection calculation server 230 for all intersections on the traveling route 411 calculated by the traveling route calculation unit 241. The intersection information reception unit 63 receives the intersection stop probabilities transmitted from the stop probability calculation server 220 and the connection information transmitted from the connection calculation server 230. The functions of the other structure units are similar to those described in Embodiment 1.

***Description of Operation***

Next, operation is described.

The present embodiment is different from Embodiment 1 and Embodiment 2 in which the traveling history accumulation process, the stop probability calculation process, the connection calculation process, and the traveling fuel efficiency estimation process are performed by independent servers. Therefore, in the present embodiment, the process at each server may be independently performed without each requiring a synchronization process.

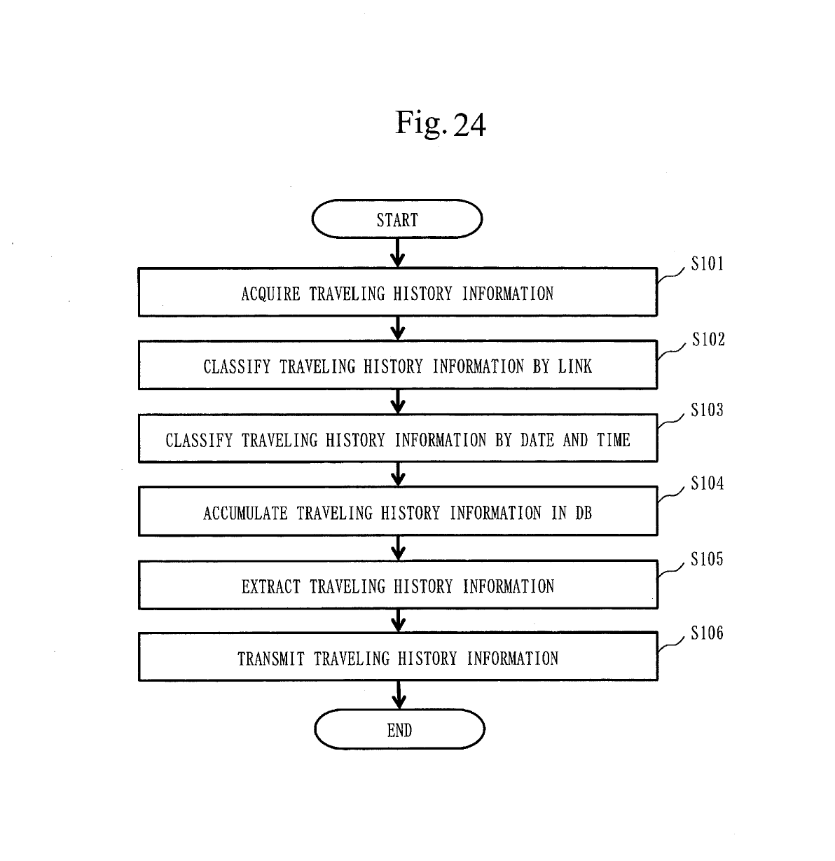

FIG. 24 is a flowchart of operation of the traveling history accumulation server 210 according to the present embodiment.

First, the traveling history reception unit 31 acquires the traveling history information 111 (step S101). Here, it is assumed that the traveling history information 111 has at least a traveling position, traveling velocity, traveling direction, and traveling date and time information and the traveling history information 111 can be information-divided by link and by date and time. Also, the traveling history information 111 may have a traveling link, acceleration, gradient, weather at the time of traveling, road congestion situation at the time of traveling, and so forth.

Next, the traveling history accumulation unit 231 classifies the traveling history information 111 by link (step S102) and further by date and time (step S103), and stores the traveling history information 111 classified by link and by date and time in the traveling history DB 251 (step S104). The processes from step S102 to step S104 are similar to the processes at step S22 to step S24, and therefore detailed description is omitted.

Next, the traveling history extraction unit 32 extracts, from the traveling history DB 251, the traveling history information 111 to be transmitted to the stop probability calculation server 220 (step S105). Here, the traveling history information 111 may be extracted at certain intervals such as once a day or may be extracted only when a request from the stop probability calculation server 220 is received.

Lastly, the traveling history transmission unit 33 transmits the extracted traveling history information 111 to the stop probability calculation server 220 (step S106).

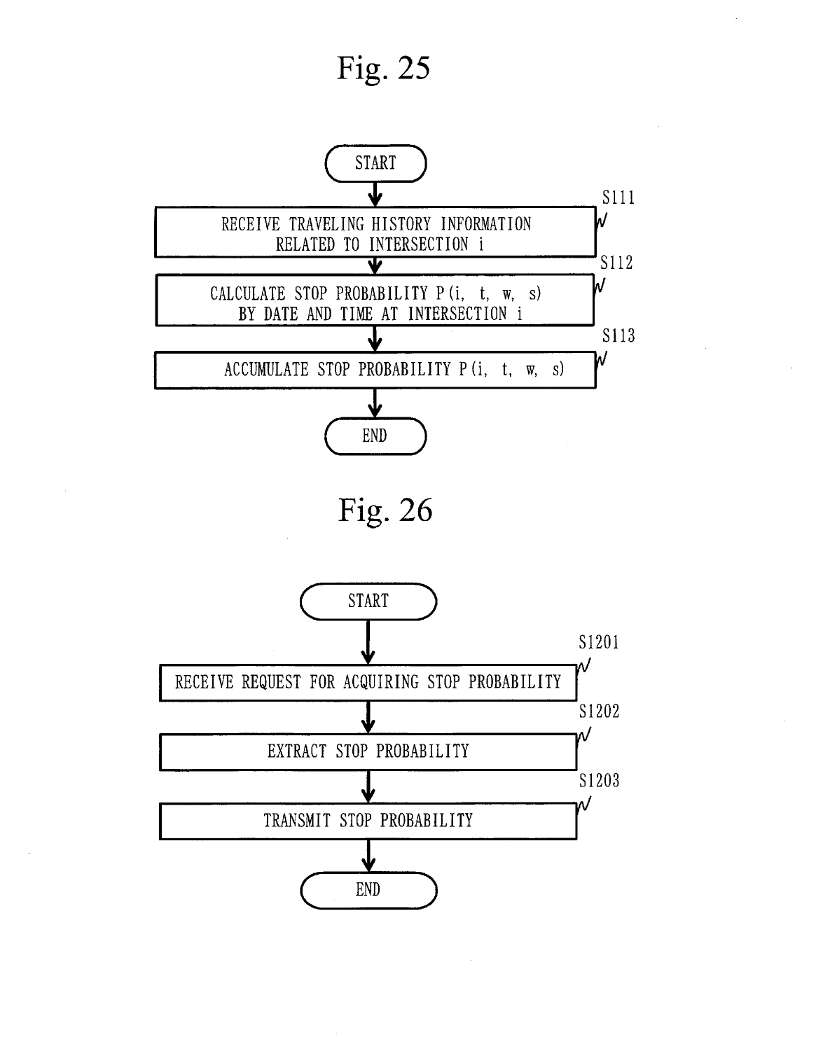

FIG. 25 is a flowchart of a stop probability calculation process of the stop probability calculation server 220 according to the present embodiment. In the following, description is exemplarily made to calculation of stop probability at the intersection i when the calculation date and time includes a traveling time t, a traveling day of the week w, and a traveling season s.

First, the traveling history reception unit 41 receives the traveling history information 111 related to the intersection i (step S111). Next, the stop probability calculation unit 233 calculates a stop probability P(i, t, w, s) by date and time at the intersection i (step S112). Lastly, the stop probability calculation unit 233 accumulates the calculated stop probability P(i, t, w, s) in the stop probability DB 252 (step S113). The processes at step S111 to step S113 are similar to the processes at step S41 to step S43, and therefore detailed description is omitted.

FIG. 26 is a flowchart of a stop probability extraction process of the stop probability calculation server 220 according to the present embodiment.

First, the acquisition request reception unit 42 receives a request for acquiring intersection information for all intersections on the traveling route 411 from the fuel efficiency calculation server 240 (step S1201). Here, the acquisition request received by the acquisition request reception unit 42 is to request acquisition of intersection information for all intersections on the traveling route 411, and is to request acquisition of intersection information including stop probabilities for all intersections on the traveling route 411. In this manner, the acquisition request can collectively process stop probabilities for a plurality of intersections.

Next, the stop probability extraction unit 43 extracts, from the stop probability DB 252, the stop probability P(i, t, w, s) at the intersection i at the time t, the day of the week w, and the season s (step S1202).

Lastly, the stop probability transmission unit 44 transmits the extracted stop probability P(i, t, w, s) to the fuel efficiency calculation server 240 (step S1203).

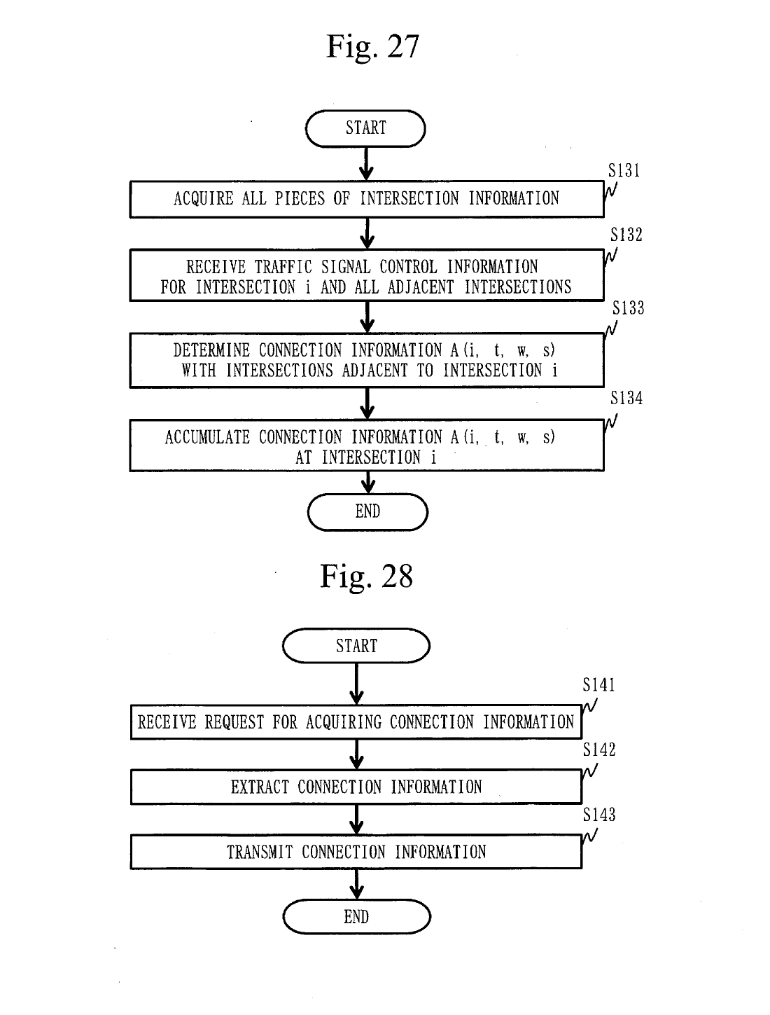

FIG. 27 is a flowchart of a connection calculation process of the connection calculation server 230 according to the present embodiment. In the following, description is exemplarily made to calculation of connection information at the intersection i when the calculation date and time is time t, day of the week w, and season s.

First, the infrastructure reception unit 51 receives the cartographic information 450, and acquires all pieces of intersection information required for calculation of connection information (step S131). Next, the infrastructure reception unit 51 acquires the traffic signal control information 471 for the intersection i and all adjacent intersections (step S132). Next, based on the received traffic signal control information 471, the connection calculation unit 232 calculates connection information for the intersection i and all adjacent intersections and takes it as connection information A(i, t, w, s) by date and time (step S133). Lastly, the connection calculation unit 232 accumulates the connection information A(i, t, w, s) for the intersection i in the connection DB 253 (step S134). The processes from step S131 to step S134 are similar to the processes at step S31 to step S34, and therefore detailed description is omitted.

FIG. 28 is a flowchart of a connection extraction process of the connection calculation server 230 according to the present embodiment. First, the acquisition request reception unit 52 receives the request for acquiring intersection information for all intersections on the traveling route 411 from the fuel efficiency calculation server 240 (step S141). Here, the acquisition request received by the acquisition request reception unit 52 is to request acquisition of intersection information for all intersections on the traveling route 411, and to request acquisition of intersection information including connection information for all intersections on the traveling route 411. In this manner, the acquisition request can collectively process connection information for a plurality of intersections. Next, the connection extraction unit 53 extracts, from the connection DB 253, the connection information A(i, t, w, s) for the intersection i at the time t, the day of the week w, and the season s (step S142). Lastly, the connection transmission unit 54 transmits the extracted connection information A(i, t, w, s) to the fuel efficiency calculation server 240 (step S143).

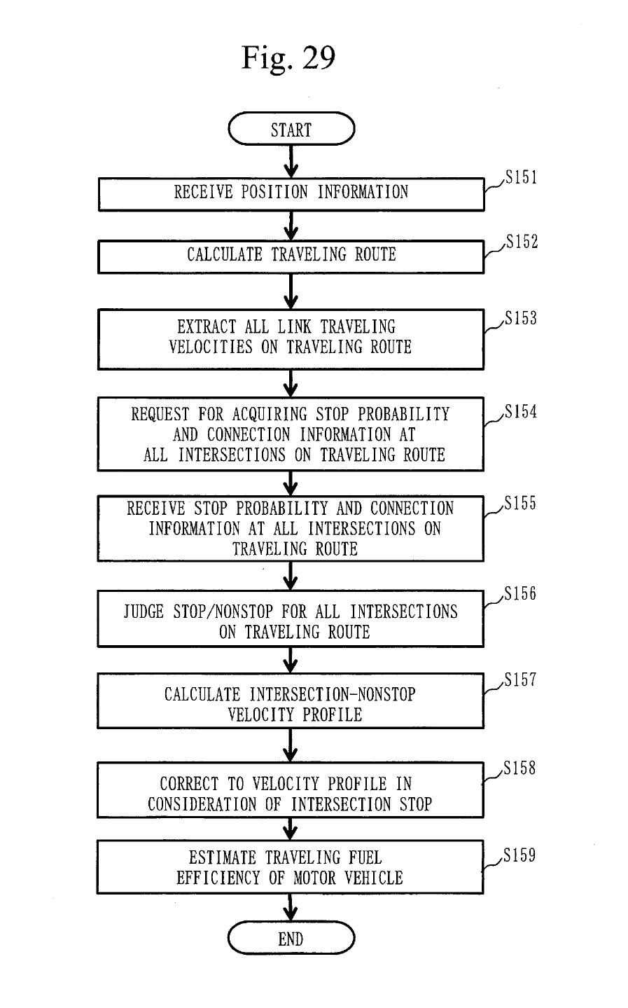

FIG. 29 is a flowchart of operation of the fuel efficiency calculation server 240 according to the present embodiment. The process of FIG. 29 is sequentially performed when the position information reception unit 61 receives the position information 121 from the motor vehicle 1b (step S151). Note that, in the following, description is exemplarily made to the case in which a date and time (time t₀, day of the week w₀, season s₀) when the position information 121 is received (acquisition date and time) is taken as an estimation date and time of traveling fuel efficiency of the motor vehicle 1b.

First, the traveling route calculation unit 241 calculates a traveling route X of the motor vehicle 1b based on the position information 121 (step S142). Next, the traveling velocity extraction unit 242 extracts the link traveling velocity V(Lₖ, tₖ, wₖ, sₖ) (1≤k≤n) for all passage links on the traveling route X from the traveling velocity DB 254 having stored in advance the link traveling velocity for all links (step S153). Here, the process at step S151 is similar to step S51, and the process at step S152 is similar to the process at step S52, and therefore detailed description is omitted.

Next, the acquisition request unit 62 requests the stop probability calculation server 220 and the connection calculation server 230 for a stop probability P(iₖ, tₖ, wₖ, sₖ) (1≤k≤m+1) and a connection information A(iₖ, tₖ, wₖ, sₖ) (1≤k≤m+1), respectively, for all intersections on the traveling route X (step S154). Next, the intersection information reception unit 63 receives the extraction result of the stop probability P(iₖ, tₖ, wₖ, sₖ) (1≤k≤m+1) and the connection information A(iₖ, tₖ, wₖ, sₖ) (1≤k≤m+1) (step S155).

Here, the operation from a time when the acquisition request unit 62 transmits the acquisition request for the stop probability and the connection information to a time when the intersection information reception unit 63 receives the extraction result of the stop probability and the connection information is as described in FIG. 26 and FIG. 28.

Next, for all intersections iₜ to iₘ on the traveling route X, the stop judgment unit 244 judges intersection stop/nonstop S(i₁) to S(iₘ) (step S156). Next, the velocity profile generation unit 245 calculates an intersection-nonstop velocity profile V_{profile-nonstop}(X) in traveling the traveling route X by using the link traveling velocity V(lₖ, tₖ, wₖ, sₖ) (1≤k≤m+1) extracted by the traveling velocity extraction unit 242 (step S157). Next, for the intersection-nonstop velocity profile V_{profile-nonstop}(X) generated by the velocity profile generation unit 245, the velocity correction unit 246 reproduces acceleration/deceleration occurring due to intersection stop by using the intersection stop/nonstop S(i₁) to S(iₘ) judged by the stop judgment unit 244, and calculates the velocity profile V_{profile}(X) in consideration of intersection stop (step S158). Lastly, for the velocity profile V_{profile}(X) in consideration of intersection stop calculated by the velocity correction unit 246, the fuel efficiency calculation unit 247 estimates motor-vehicle traveling fuel efficiency in traveling the traveling route X by using the relational expression of fuel efficiency and traveling velocity (step S159).

Here, the process at step S156 is similar to the process at step S54, the process at step S157 is similar to the process at step S55, the process at step S158 is similar to step S56, and the process at step S159 is similar to step S57, and therefore detailed description is omitted.

***Description of Effects According to Present Embodiment***

As described above, according to the fuel efficiency estimation system 500b of the present embodiment, the servers are distributed to allow the loads of the respective processes to be distributed. This can provide support without consideration of influences of load on another process when, for example, a large amount of traveling history information will be gathered in the future or it is desired to increase the frequency of calculation and updating of the intersection stop probability to enhance reproduction accuracy.

### Embodiment 4

In the present embodiment, differences from Embodiments 1 to 3 are mainly described.

In the present embodiment, a structure similar to the structure described in Embodiments 1 to 3 is provided with a same reference character and its description is omitted.

***Description of Structure***

In Embodiments 1 to 3, the structure is such that processing is performed only at the motor vehicle and the central server. However, the stop probability at the intersection and the connection information about the intersections can be calculated for each intersection, and can be processed by edge computing.

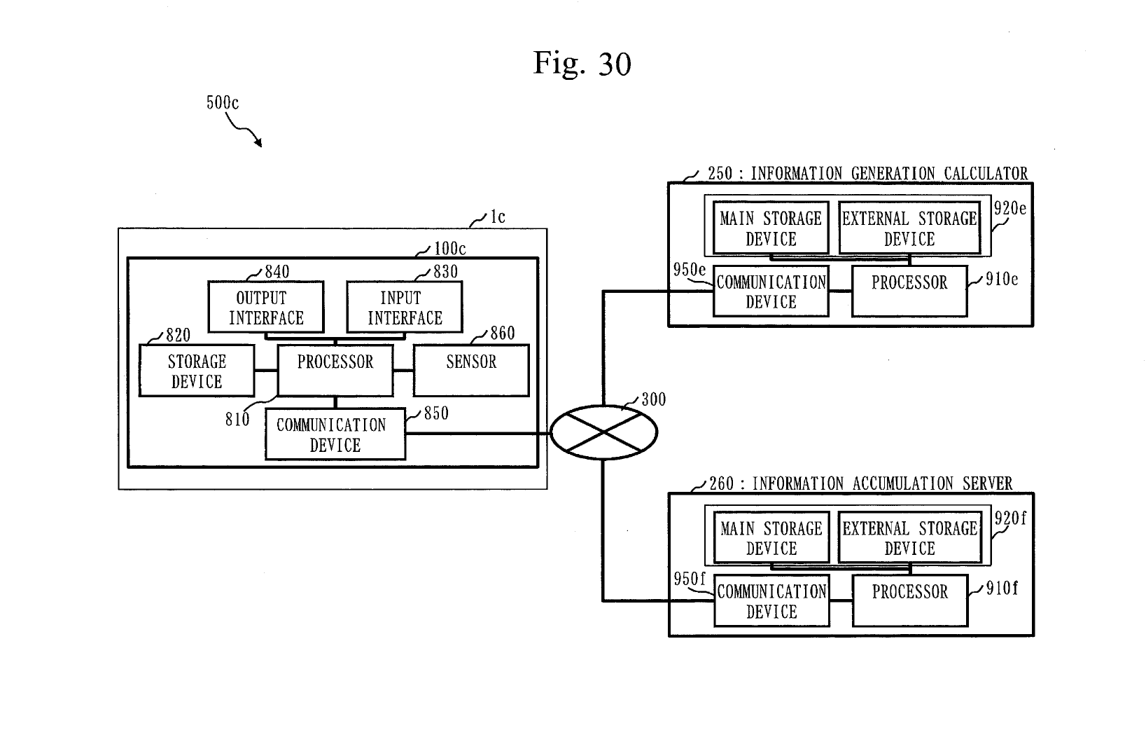

FIG. 30 illustrates a system structure of a fuel efficiency estimation system 500c according to the present embodiment. FIG. 30 illustrates a hardware structure of each device configuring the fuel efficiency estimation system 500c.

In FIG. 30, the fuel efficiency estimation system 500c is configured of a motor vehicle device 100c mounted on a motor vehicle 1c, an information generation calculator 250, and an information accumulation server 260. Here, the configuration is taken in which one information generation calculator 250 is installed at each intersection on the roads nationwide. The information generation calculator 250 is also referred to as an intersection information generation calculator 250.

The motor vehicle device 100c, the information generation calculator 250, and the information accumulation server 260 communicate with each other via the network 300.

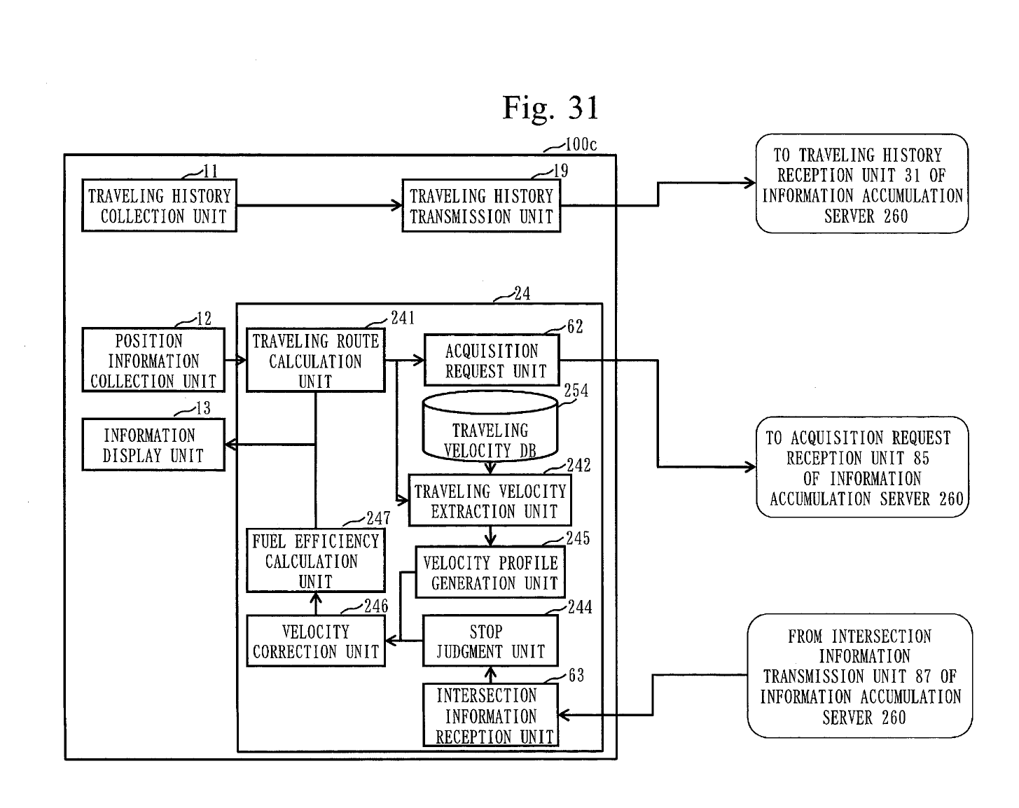

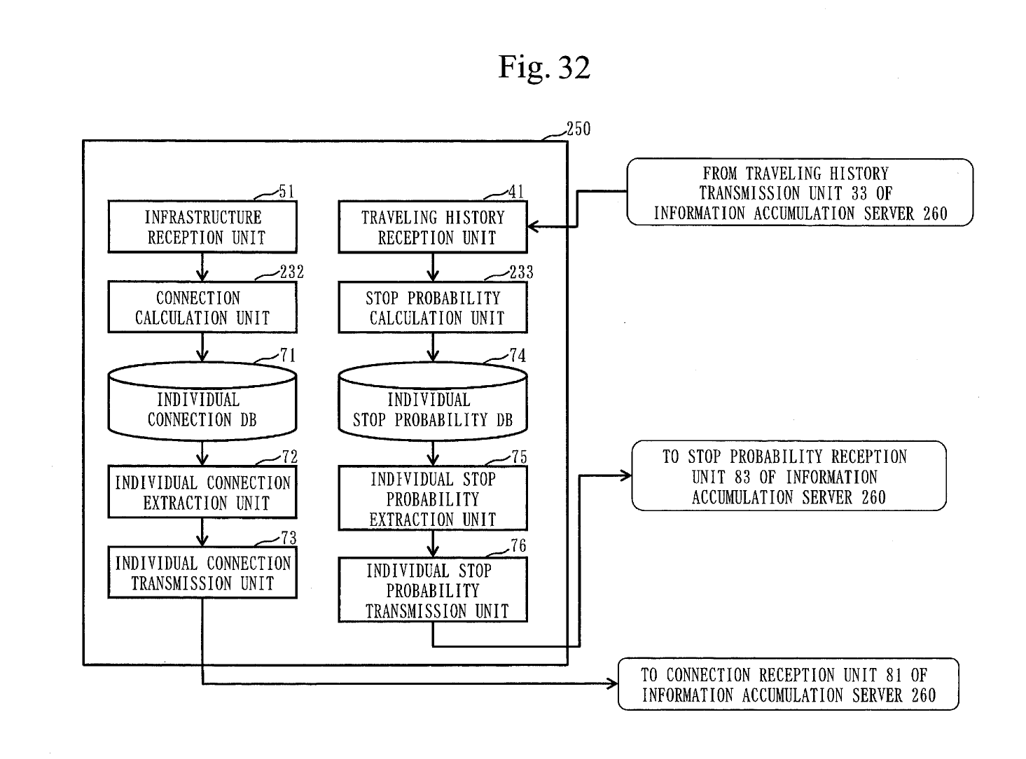

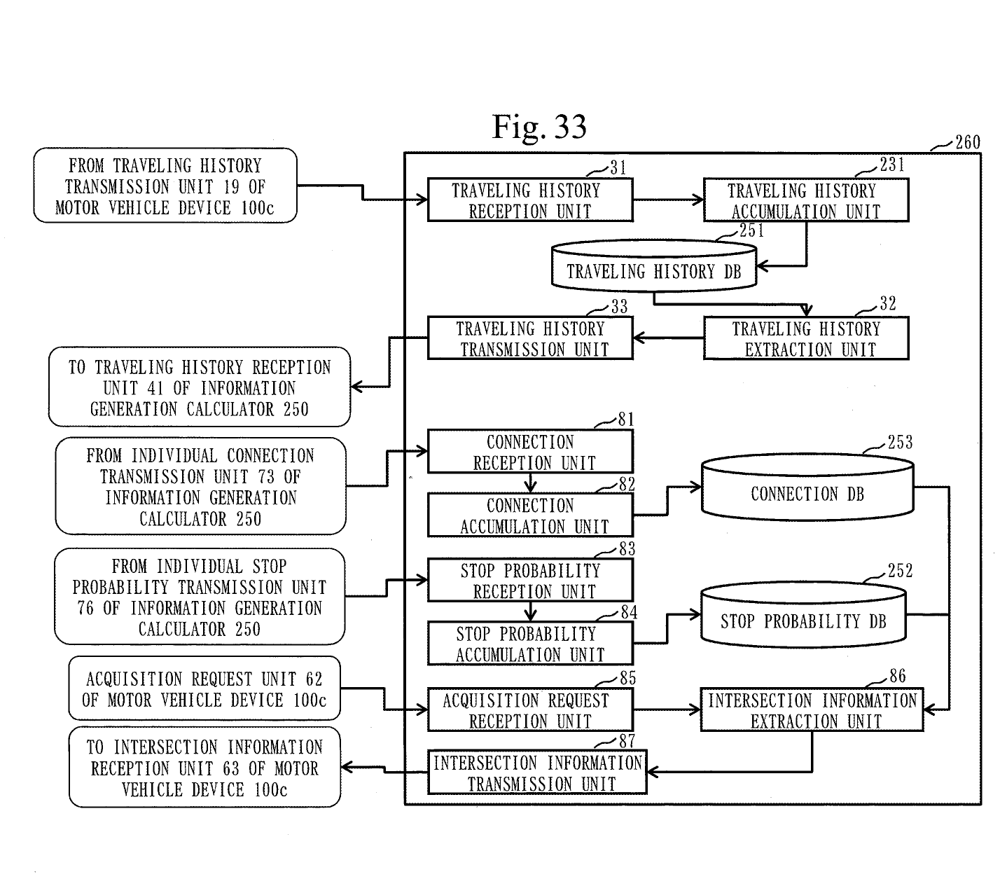

FIG. 31 illustrates a functional structure of the motor vehicle device 100c according to the present embodiment. FIG. 32 illustrates a functional structure of the information generation calculator 250 according to the present embodiment. FIG. 33 illustrates a functional structure of the information accumulation server 260 according to the present embodiment.

The motor vehicle device 100c includes the traveling history collection unit 11, the position information collection unit 12, and the information display unit 13. Also, the motor vehicle device 100c includes the traveling history transmission unit 19 which transmits the traveling history information 111 to the information accumulation server 260 and the traveling fuel efficiency estimation unit 24 which calculates the traveling route 411 and estimates traveling fuel efficiency of the traveling route 411 based on the position information 121 and the cartographic information 450.

The traveling fuel efficiency estimation unit 24 includes the traveling route calculation unit 241, the traveling velocity extraction unit 242, the traveling velocity DB 254, the stop judgment unit 244, the velocity profile generation unit 245, the velocity correction unit 246, and the fuel efficiency calculation unit 247 described in Embodiment 1. Also, the traveling fuel efficiency estimation unit 24 includes the acquisition request unit 62 and the intersection information reception unit 63 described in Embodiment 3. The acquisition request unit 62 requests the information accumulation server 260 to acquire intersection information for all intersections on the traveling route. The intersection information for all intersections on the traveling route includes stop probabilities and connection information.

The information generation calculator 250 includes the connection calculation unit 232 and the stop probability calculation unit 233 described in Embodiment 1. Also, the information generation calculator 250 includes the infrastructure reception unit 51 and the traveling history reception unit 41 described in Embodiment 1.

The information generation calculator 250 includes an individual connection DB 71 which stores the connection information at the specific intersection calculated by the connection calculation unit 232 and an individual connection extraction unit 72 which extracts the connection information at the specific intersection from the individual connection DB 71. Furthermore, the information generation calculator 250 includes an individual connection transmission unit 73 which transmits the connection information extracted by the individual connection extraction unit 72 to the information accumulation server 260.

Also, the information generation calculator 250 includes an individual stop probability DB 74 which stores the stop probability at the specific intersection calculated by the stop probability calculation unit 233 and an individual stop probability extraction unit 75 which extracts the stop probability at the specific intersection from the individual stop probability DB 74. Furthermore, the information generation calculator 250 includes an individual stop probability transmission unit 76 which transmits the stop probability extracted by the individual stop probability extraction unit 75 to the information accumulation server 260.

The information accumulation server 260 includes the following structure units described in Embodiments 1 to 3. The information accumulation server 260 includes the traveling history DB 251 which accumulates the traveling history information 111. The information accumulation server 260 includes the traveling history reception unit 31 which receives the traveling history information 111 transmitted from the motor vehicle device 100c, the traveling history accumulation unit 231 which accumulates the traveling history information 111 in the traveling history DB 251, and the traveling history extraction unit 32 which extracts the required traveling history information 111 from the traveling history DB 251. Also, the information accumulation server 260 includes the traveling history transmission unit 33 which transmits the extracted traveling history information 111 to the information generation calculator 250 at an individual intersection. Also, the information accumulation server 260 includes the connection DB 253 and the stop probability DB 252.

Furthermore, the information accumulation server 260 includes a connection reception unit 81 which receives connection information from the information generation calculator 250 at each intersection and a connection accumulation unit 82 which accumulates the received connection information. Also, the information accumulation server 260 includes a stop probability reception unit 83 which receives a stop probability from the information generation calculator 250 at each intersection and a stop probability accumulation unit 84 which accumulates the received stop probability. Furthermore, the information accumulation server 260 includes an acquisition request reception unit 85 which accepts the connection information at each intersection and a request for acquiring a stop probability from the motor vehicle device 100c and an intersection information extraction unit 86 which extracts the connection information at the intersection and the stop probability requested for acquisition from the connection DB 253 and the stop probability DB 252, respectively. Still further, the information accumulation server 260 includes an intersection information transmission unit 87 which transmits the extracted connection information at each intersection and stop probability to the motor vehicle device 100c.

By using FIG. 30, the hardware structure in the present embodiment is described.

In the fuel efficiency estimation system 500c according to the present embodiment, each of the motor vehicle device 100c mounted on the motor vehicle 1c, the information generation calculator 250, and the information accumulation server 260 is a computer. Here, one information generation calculator 250 is held for each of the intersections nationwide. Also, the information accumulation server 260 may be a substantial data server or may be configured in the cloud.

The hardware structure of the motor vehicle device 100c of the motor vehicle 1c is similar to that described in Embodiments 1 to 3.

The information generation calculator 250 and the information accumulation server 260 each include the processor 910, the storage device 920, and the communication device 950. Basic functions of the processor 910, the storage device 920, and the communication device 950 in each server are similar to those described in Embodiments 1 to 3. As illustrated in FIG. 30, the hardware pieces in each of the information generation calculator 250 and the information accumulation server 260 are described as being distinguished with a subscript e or f added to the reference numeral of each hardware piece.

The information generation calculator 250 is described. A storage device 920e includes a main storage device which temporarily stores the process result regarding generation of stop probability at intersections and generation of connection information and an external storage device which stores stop probability at each intersection and connection information. A processor 910e performs arithmetic operation process regarding generation of stop probability at intersections and generation of connection information. A communication device 950e transmits and receives the traveling history information, connection information, stop probability, cartographic information, traffic signal control information, and so forth.

The information accumulation server 260 is described. A storage device 920f includes a main storage device which temporarily stores the process result regarding accumulation and extraction of the traveling history information, connection information, and stop probability and an external storage device which stores the traveling history information, connection information, and stop probability. A processor 910f performs arithmetic operation process regarding accumulation and extraction of the traveling history information, connection information, and stop probability. A communication device 950f transmits and receives the traveling history information, connection information, stop probability, cartographic information, and an acquisition request.

As described above, in the present embodiment, a structure is taken in which the process of estimating motor-vehicle traveling fuel efficiency is performed on a motor vehicle side and the intersection information required for estimation is acquired from the information accumulation server 260. Also, a structure is taken in which a process calculator is held for each intersection and the process of generating connection information and stop probability is individually processed for each intersection. This allows the process of generating connection information and stop probability required for improving accuracy of estimation of motor-vehicle traveling fuel efficiency, the process of calculating estimated fuel efficiency, and the information accumulation process to be separated from one another to reduce a process load. In particular, with a process calculator held for each intersection, the process per process calculator can be reduced, and the size of the process calculator itself can be decreased.

***Description of Operation***

Next, the operation is described.

In the present embodiment, the traveling fuel efficiency estimation process is performed at the motor vehicle 1c, the reference velocity judgment process and the traveling velocity generation process are performed at the information generation calculator 250, and the traveling history accumulation process and the traveling velocity accumulation process are performed at the information accumulation server 260. The operation of each device may be performed independently from one another.

The traveling history accumulation process in the information accumulation server 260 is performed by the traveling history reception unit 31, the traveling history accumulation unit 231, the traveling history DB 251, the traveling history extraction unit 32, and the traveling history transmission unit 33 of the information accumulation server 260. The present process is similar to the process of the traveling history accumulation server 210 in Embodiment 3 illustrated in FIG. 20, and therefore its description is omitted.

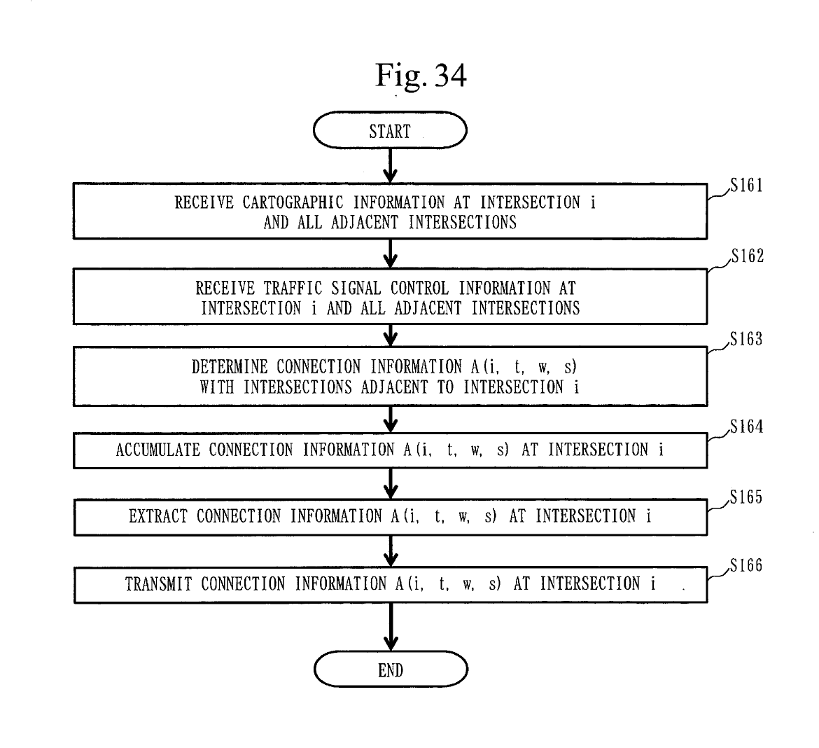

FIG. 34 is a flowchart of an individual connection calculation process of the information generation calculator 250 according to the present embodiment. In the following, description is exemplarily made to calculation of the connection information at the intersection i when the calculation date and time includes a traveling time t, a traveling day of the week w, and a traveling season s.

First, the infrastructure reception unit 51 receives the cartographic information 450 to acquire all pieces of intersection information required for calculation of connection information (step S161). Next, the infrastructure reception unit 51 acquires the traffic signal control information 471 about the intersection i and all adjacent intersections (step S162). Next, based on the received traffic signal control information 471, the connection calculation unit 232 calculates connection information about the intersection i and all adjacent intersections and takes it as connection information A(i, t, w, s) by date and time (step S163). Next, the connection calculation unit 232 accumulates the connection information A(i, t, w, s) for the intersection i in the individual connection DB 71 (step S164). Next, the individual connection extraction unit extracts the connection information A(i, t, w, s) for the intersection i accumulated in the individual connection DB 71 (step S165). Lastly, the individual connection transmission unit 73 transmits the connection information A(i, t, w, s) for the intersection i to the information accumulation server 260 (step S166). Here, the processes from step S161 to step S164 are similar to the processes from step S31 to step S34, and therefore detailed description is omitted.

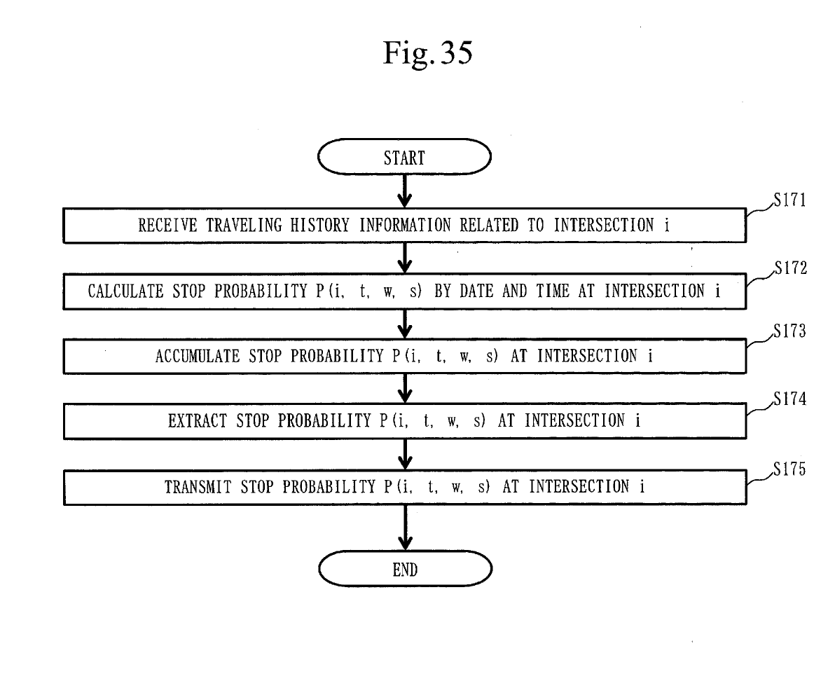

FIG. 35 is a flowchart of an individual stop probability calculation process of the information generation calculator 250 according to the present embodiment. In the following, description is exemplarily made to calculation of the stop probability at the intersection i when the calculation date and time includes a traveling time t, a traveling day of the week w, and a traveling season s.

First, the traveling history reception unit 41 receives traveling history information related to the intersection i (step S171). Next, the stop probability calculation unit 233 calculates a stop probability P(i, t, w, s) by date and time at the intersection i (step S172). Next, the calculated stop probability P(i, t, w, s) is accumulated in the individual stop probability DB 74 (step S173). Next, the individual stop probability extraction unit 75 extracts the stop probability P(i, t, w, s) at the intersection i (step S174). Lastly, the individual stop probability transmission unit 76 transmits the stop probability P(i, t, w, s) at the intersection i to the information accumulation server 260 (step S175). Here, the processes from step S171 to step S173 are similar to the processes from step S41 to step S43, and therefore detailed description are omitted.

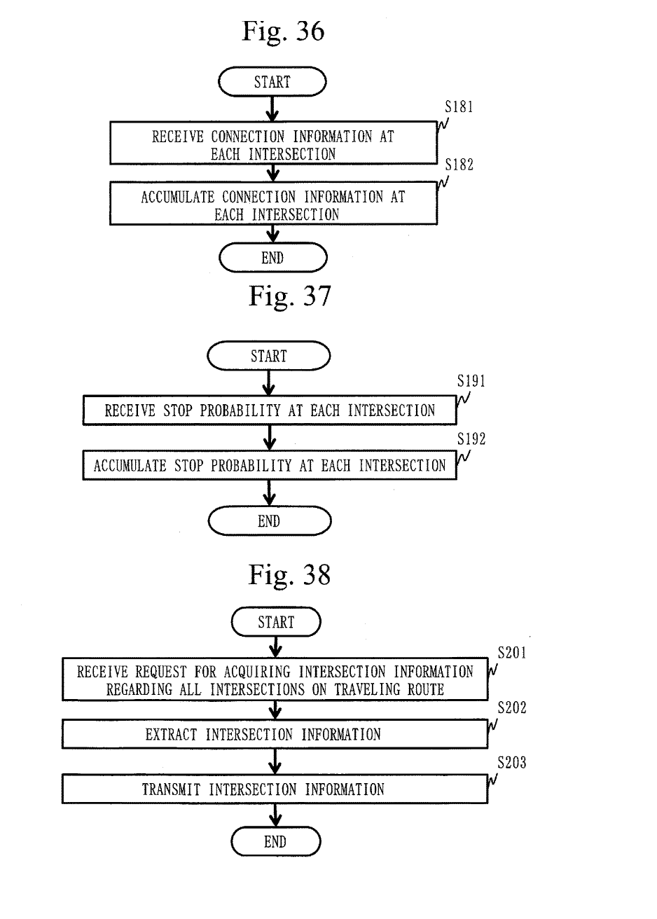

FIG. 36 is a flowchart of a connection accumulation process of the information accumulation server 260 according to the present embodiment. The present process may be in a form of being performed with the timing of receiving the connection information or in a form of being performed as scheduled, such as one per day.

First, the connection reception unit 81 receives connection information about each intersection transmitted from the information generation calculator 250 (step S181). Next, the connection accumulation unit 82 accumulates the received connection information about each intersection in the connection DB 253 (step S182). Here, the information accumulation server 260 may collectively receive and process information at a plurality of intersections.

FIG. 37 is a flowchart of a stop probability accumulation process of the information accumulation server 260 according to the present embodiment. The present process may be in a form of being performed with the timing of receiving the stop probability or in a form of being performed as scheduled, such as one per day.

First, the stop probability reception unit 83 receives the stop probability at each intersection transmitted from the information generation calculator 250 (step S191). Next, the stop probability accumulation unit 84 accumulates the received stop probability at each intersection in the stop probability DB 252 (step S192). Here, the information accumulation server 260 may collectively receive and process information at a plurality of intersections.

FIG. 38 is a flowchart of an intersection information extraction process of the information accumulation server 260 according to the present embodiment. First, the acquisition request reception unit 85 receives a request for acquiring connection information and a stop probability as intersection information regarding a specific intersection from the motor vehicle device 100c (step S201). Here, the acquisition request reception unit 85 can simultaneously receive and process intersection information at a plurality of intersections.

Next, the intersection information extraction unit 86 extracts the connection information and the stop probability at the specific intersection requested for acquisition from the connection DB 253 and the stop probability DB 252, respectively (step S202).

Lastly, the intersection information transmission unit 87 transmits the extracted connection information and stop probability at the specific intersection to the motor vehicle device 100c (step S203). Here, the intersection information transmission unit 87 may collectively transmit and process intersection information at a plurality of intersections.

The fuel efficiency estimation process at the motor vehicle 1c is performed at the traveling fuel efficiency estimation unit 24. The present process is sequentially performed when the position information collection unit 12 receives the position information 121 including the origin and the destination from the driver. The processes after those of the traveling fuel efficiency estimation unit 24 are similar to the processes of the fuel efficiency calculation server 240 in Embodiment 3, and therefore description is omitted.

***Description of Effects According to Present Embodiment***

The fuel efficiency estimation system 500c according to the present embodiment has an information generation calculator for each intersection. The information generation calculator calculates a stop probability at a specific date and time from the traveling history information and the cartographic information as infrastructure information. Also, the information generation calculator calculates traffic signal connection information at all intersections from the cartographic information and traffic signal control information as infrastructure information.

Also, the fuel efficiency estimation system 500c has an information accumulation server which accumulates the traveling history information collected from the motor vehicle and the traffic signal connection information and the intersection stop probability calculated at each intersection. Furthermore, the fuel efficiency estimation system 500c has a motor vehicle which performs a motor-vehicle traveling fuel efficiency estimation process for estimating traveling fuel efficiency by calculating a velocity profile representing a velocity change situation at the time of traveling also in consideration of an intersection stop for a specific traveling route.

As described above, according to the fuel efficiency estimation system 500c of the present embodiment, the process calculator is installed for each intersection to allow the processes to be distributed. This allows the process at each process unit to be minimized, and the process load at one calculator can be reduced.

While Embodiments 1 to 4 of the present invention have been described in the foregoing, among the “units” in the description of these embodiments, only one may be adopted, or any combination of several units may be adopted. That is, any functional block of the fuel efficiency estimation system that can achieve the function described in the above embodiments can be taken. The fuel efficiency estimation system may be configured by any combination of these functional blocks or by any functional blocks.

Also, while Embodiments 1 to 4 have been described, a plurality of embodiments among these embodiments may be combined for implementation. Also, among these embodiments, a plurality of portions may be combined for implementation. Alternatively, among these embodiments, one portion may be implemented. In addition, the details of these embodiments may be entirely or partially implemented in any combination.

Note that the above embodiments are intrinsically preferable examples, are not intended to limit the scope of the present invention, its applications, and its use purposes, and can be variously modified as required. The above embodiments are to help understanding the present scheme and are not to limit the invention.

### REFERENCE SIGNS LIST

1, 1a, 1b, 1c: motor vehicle; 100, 100a, 100b, 100c: motor vehicle device; 11: traveling history collection unit; 12: position information collection unit; 13: information display unit; 14: information transmission unit; 15: information reception unit; 16: storage unit; 17: position information transmission unit; 18: route and fuel efficiency information reception unit; 19: traveling history transmission unit; 111: traveling history information; 121: position information; 411: traveling route; 450: cartographic information; 461: fuel efficiency estimation result; 471: traffic signal control information; 210: traveling history accumulation server; 31: traveling history reception unit; 32: traveling history extraction unit; 33: traveling history transmission unit; 220: stop probability calculation server; 41: traveling history reception unit; 42: acquisition request reception unit; 43: stop probability extraction unit; 44: stop probability transmission unit; 230: connection calculation server; 51: infrastructure reception unit; 52: acquisition request reception unit; 53: connection extraction unit; 54: connection transmission unit; 240: fuel efficiency calculation server; 61: position information reception unit; 62: acquisition request unit; 63: intersection information reception unit; 250: information generation calculator; 71: individual connection DB; 72: individual connection extraction unit; 73: individual connection transmission unit; 74: individual stop probability DB; 75: individual stop probability extraction unit; 76: individual stop probability transmission unit; 260: information accumulation server; 81: connection reception unit; 82: connection accumulation unit; 83: stop probability reception unit; 84: stop probability accumulation unit; 85: acquisition request reception unit; 86: intersection information extraction unit; 87: intersection information transmission unit; 200: fuel efficiency estimation device; 21: information reception unit; 22: information transmission unit; 23: stop judgment generation unit; 24: traveling fuel efficiency estimation unit; 25: storage unit; 231: traveling history accumulation unit; 232: connection calculation unit; 233: stop probability calculation unit; 321: connection information; 331: stop probability; 241: traveling route calculation unit; 244: stop judgment unit; 242: traveling velocity extraction unit; 245: velocity profile generation unit; 246: velocity correction unit; 247: fuel efficiency calculation unit; 441, 451: velocity profile; 251: traveling history DB; 252: stop probability DB; 253: connection DB; 254: traveling velocity DB; 300: network; 500, 500a, 500b, 500c: fuel efficiency estimation system; 510: fuel efficiency estimation method; 520: fuel efficiency estimation program; 809, 909: processing circuit; 810, 910, 910a, 910b, 910c, 910d, 910e, 910f: processor; 820, 920, 920a, 920b, 920c, 920d, 920e, 920f: storage device; 830: input interface; 840: output interface; 850, 950, 950a, 950b, 950c, 950d, 950e, 950f: communication device; 860: sensor; S120: traveling fuel efficiency estimation process; S121: stop judgment process; S122: velocity profile generation process; S1203: velocity correction process; S124: fuel efficiency calculation process; 2510: traveling history storage unit; 2520: stop probability storage unit; 2530: connection storage unit; 2540: traveling velocity storage unit

1-16. (canceled)

17. A fuel efficiency estimation system comprising:
processing circuitry
to generate a velocity profile indicating a change in velocity of a motor vehicle traveling a traveling route where a plurality of intersections are present,
for the plurality of intersections, to calculate connected/disconnected operation between a traffic signal installed at each intersection and a traffic signal installed at an intersection adjacent to each intersection, as connection information,
for the plurality of intersections, to correct a stop probability at each intersection, based on the connection information, a stop probability at which the motor vehicle stops at each intersection, and a stop probability at which the motor vehicle stops at the adjacent intersection, and to judge stop/nonstop of the motor vehicle at each intersection based on the corrected stop probability at each intersection,
to correct the velocity profile based on the stop/nonstop at all intersections of the plurality of intersections, and
to calculate fuel efficiency of the motor vehicle traveling the traveling route based on the corrected velocity profile.

18. The fuel efficiency estimation system according to claim 17, wherein
the processing circuitry, for the plurality of intersections, if the traffic signal installed at each intersection and the traffic signal installed at the adjacent intersection are connected, performs a correction of treating a sum of the stop probability at which the motor vehicle stops at each intersection and the stop probability at which the motor vehicle stops at the adjacent intersection, as a stop probability at which the motor vehicle stops at each intersection, and if the traffic signal installed at each intersection and the traffic signal installed at the adjacent intersection are not connected, does not perform the correction.

19. The fuel efficiency estimation system according to claim 18, wherein
the processing circuitry calculates the connection information based on cartographic information and traffic signal control information as infrastructure information.

20. The fuel efficiency estimation system according to claim 19, wherein
the processing circuitry calculates the connection information for each of date and time attributes as attributes of date and time and stores the connection information.

21. The fuel efficiency estimation system according to claim 19, wherein:
the processing circuitry calculates the stop probability based on traveling history information collected from a motor vehicle previously traveling the traveling route.

22. The fuel efficiency estimation system according to claim 21, wherein
the processing circuitry calculates the stop probability for each of date and time attributes as attributes of date and time and stores the stop probability.

23. The fuel efficiency estimation system according to claim 21, wherein the processing circuitry
acquires position information including an origin and a destination, and
generates the velocity profile based on an acquisition date and time when the position information has been acquired and a traveling velocity for each of road sections configuring the traveling route when the traveling route is traveled with the date and time attributes of the acquisition date and time.

24. The fuel efficiency estimation system according to claim 23, comprising:
a motor vehicle device mounted on the motor vehicle traveling the traveling route and a fuel efficiency estimation device to communicate with the motor vehicle device, wherein
the processing circuitry of the motor vehicle device transmits the position information to the fuel efficiency estimation device, and
the processing circuitry of the fuel efficiency estimation device calculates the traveling route based on the position information.

25. The fuel efficiency estimation system according to claim 24, wherein
the processing circuitry of the motor vehicle device further transmits traveling history information indicating traveling history of the motor vehicle to the fuel efficiency estimation device, and
the processing circuitry of the fuel efficiency estimation device accumulates the traveling history information.

26. The fuel efficiency estimation system according to claim 25, wherein
the processing circuitry
calculates the stop probability based on the traveling history information collected from the motor vehicle previously traveling the traveling routes,
for the plurality of intersections, calculates the connected/disconnected operation between the traffic signal installed at each intersection and the traffic signal installed at the intersection adjacent to each intersection, as the connection information,
generates the velocity profile indicating the change in velocity of the motor vehicle traveling the traveling route where the plurality of intersections are present,
for the plurality of intersections, corrects the stop probability at each intersection, based on the connection information, the stop probability at which the motor vehicle stops at each intersection, and the stop probability at which the motor vehicle stops at the adjacent intersection, and judges the stop/nonstop of the motor vehicle at each intersection based on the corrected stop probability at each intersection,
corrects the velocity profile based on the stop/nonstop at all intersections of the plurality of intersections, and
calculates the fuel efficiency of the motor vehicle traveling the traveling route based on the corrected velocity profile.

27. The fuel efficiency estimation system according to claim 23, comprising:
a motor vehicle device mounted on the motor vehicle traveling the traveling route, wherein
the processing circuitry of the motor vehicle device
calculates the traveling route based on the position information,
collects traveling history information indicating traveling history of the motor vehicle,
accumulates the traveling history information,
calculates the stop probability based on the traveling history information collected from the motor vehicle previously traveling the traveling routes,
for the plurality of intersections, calculates the connected/disconnected operation between the traffic signal installed at each intersection and the traffic signal installed at the intersection adjacent to each intersection, as the connection information,
generates the velocity profile indicating the change in velocity of the motor vehicle traveling the traveling route where the plurality of intersections are present,
for the plurality of intersections, corrects the stop probability at each intersection, based on the connection information, the stop probability at which the motor vehicle stops at each intersection, and the stop probability at which the motor vehicle stops at the adjacent intersection, and judges the stop/nonstop of the motor vehicle at each intersection based on the corrected stop probability at each intersection,
corrects the velocity profile based on the stop/nonstop at all intersections of the plurality of intersections, and
calculates the fuel efficiency of the motor vehicle traveling the traveling route based on the corrected velocity profile.

28. The fuel efficiency estimation system according to claim 23, comprising:
a motor vehicle device mounted on the motor vehicle traveling the traveling route, the processing circuitry of the motor vehicle device transmitting the position information and traveling history information indicating traveling history of the motor vehicle;
a traveling history accumulation server to receive the traveling history information from the motor vehicle device and to accumulate the traveling history information;
a stop probability calculation server to receive the traveling history information from the traveling history accumulation server and to calculate the stop probability based on the traveling history information;
a connection calculation server to receive the infrastructure information from the motor vehicle device and to calculate the connection information based on the infrastructure information; and
a fuel efficiency calculation server
to receive the position information from the motor vehicle device,
to generate the velocity profile indicating the change in velocity of the motor vehicle traveling the traveling route where the plurality of intersections are present,
for the plurality of intersections, to correct the stop probability at each intersection, based on the connection information, the stop probability at which the motor vehicle stops at each intersection, and the stop probability at which the motor vehicle stops at the adjacent intersection, and to judge the stop/nonstop of the motor vehicle at each intersection based on the corrected stop probability at each intersection,
to correct the velocity profile based on the stop/nonstop at all intersections of the plurality of intersections, and
to calculate the fuel efficiency of the motor vehicle traveling the traveling route based on the corrected velocity profile.

29. The fuel efficiency estimation system according to claim 21, comprising:
a motor vehicle device mounted on the motor vehicle traveling the traveling route, the processing circuitry of the motor vehicle device transmitting traveling history information indicating traveling history of the motor vehicle;
an information generation calculator provided for each intersection that is present on the traveling route and for calculating the stop probability based on the traveling history information and calculating the connection information based on the infrastructure information; and
an information accumulation server
to receive the traveling history information from the motor vehicle device,
to accumulate the traveling history information,
to receive the stop probability from the information generation calculator and to store the received stop probability, and
to receive the connection information from the information generation calculator and to store the received connection information.

30. The fuel efficiency estimation system according to claim 29, wherein
the processing circuitry of the motor vehicle device
calculates a traveling route based on position information including an origin and a destination,
receives the stop probability and the connection information from the information accumulation server,
generates the velocity profile indicating the change in velocity of the motor vehicle traveling the traveling route where the plurality of intersections are present,
for the plurality of intersections, to correct the stop probability at each intersection, based on the connection information, the stop probability at which the motor vehicle stops at each intersection, and the stop probability at which the motor vehicle stops at the adjacent intersection, and judges the stop/nonstop of the motor vehicle at each intersection based on the corrected stop probability at each intersection,
corrects the velocity profile based on the stop/nonstop at all intersections of the plurality of intersections, and
calculates the fuel efficiency of the motor vehicle traveling the traveling route based on the corrected velocity profile.

31. A fuel efficiency estimation method comprising:
generating a velocity profile indicating a change in velocity of a motor vehicle traveling a traveling route where a plurality of intersections are present;
for the plurality of intersections, calculating connected/disconnected operation between a traffic signal installed at each intersection and a traffic signal installed at an intersection adjacent to each intersection, as connection information;
for the plurality of intersections, correcting a stop probability at each intersection, based on the connection information, a stop probability at which the motor vehicle stops at each intersection, and a stop probability at which the motor vehicle stops at the adjacent intersection, and judging stop/nonstop of the motor vehicle at each intersection based on after-correction stop probability at each intersection;
correcting the velocity profile based on the stop/nonstop at all intersections of the plurality of intersections; and
calculating fuel efficiency of the motor vehicle traveling the traveling route based on the corrected velocity profile.

32. A non-transitory computer readable medium storing a fuel efficiency estimation program that causes a computer to execute:
a velocity profile generation process of generating a velocity profile indicating a change in velocity of a motor vehicle traveling a traveling route where a plurality of intersections are present;
a connection calculation process of, for the plurality of intersections, calculating connected/disconnected operation between a traffic signal installed at each intersection and a traffic signal installed at an intersection adjacent to each intersection, as connection information;
a stop judgment process of, for the plurality of intersections, correcting a stop probability at each intersection, based on the connection information, a stop probability at which the motor vehicle stops at each intersection, and a stop probability at which the motor vehicle stops at the adjacent intersection, and judging stop/nonstop of the motor vehicle at each intersection based on the corrected stop probability at each intersection;
a velocity correction process of correcting the velocity profile based on the stop/nonstop at all intersections of the plurality of intersections; and
a fuel efficiency calculation process of calculating fuel efficiency of the motor vehicle traveling the traveling route based on the velocity profile corrected by the velocity correction process.
